(19) United States
(12) Patent Application Publication
(10) Pub. No.: US 2015/0211485 A1
(43) Pub. Date: Jul. 30, 2015

(54) VERTICAL-AXIS FLUID TURBINE

(71) Applicant: Transco Products, Inc., Chicago, IL (US)

(72) Inventor: Michael Tortorello, Oak Lawn, IL (US)

(21) Appl. No.: 14/608,463

(22) Filed: Jan. 29, 2015

Related U.S. Application Data
(60) Provisional application No. 61/933,412, filed on Jan. 30, 2014.
(60) Provisional application No. 61/985,794, filed on Apr. 29, 2014.

(51) Int. Cl. F03D 7/02; F03D 7/04; F03D 3/06

(52) U.S. Cl. CPC F03D 7/024; F03D 3/062; F03D 7/04

(57) ABSTRACT

The present invention provides a motion-translation mechanism for rotating blades of a vertical-axis wind turbine. Two or more axles are mounted for rotation about the first axis and each having a first end connected to the power shaft and the second end having a blade holder. A surface is mounted circumjacent the power shaft and is axially spaced from the two axles and the shape of the surface defines the path of each of the connector arms as each connector arm assembly rotates radially about the surface while maintaining connection to the blade holder. Each connector arm has a third end and a fourth end opposed to the third end. The third end being connected to its associated blade holder, the fourth end being in cooperative engagement with the surface. Each fourth end moves from a maximum vertical displacement to a minimum vertical displacement then from a minimum vertical displacement to a maximum vertical displacement during a single rotation of the power shaft thus causing the blade holders along with the attached blades to rotate positive 90° then negative 90 degrees about the second axis of rotation.

### CROSS REFERENCE TO RELATED APPLICATIONS

This application claims priority to U.S. Provisional Patent Application No. 61/933,412 filed on Jan. 30, 2014 and U.S. Provisional Patent Application No. 61/985,794 filed on Apr. 29, 2014, both of which are incorporated herein in their entirety by reference and made a part hereof.

### FIELD OF THE INVENTION

The present invention provides a vertical-axis fluid turbine and more particularly a vertical-axis wind turbine having blades that are vertical when rotating with the wind and horizontal when rotating against the wind.

### BACKGROUND OF THE INVENTION

Wind turbines and wind mills have been used for many years to harvest energy from the wind for use for other tasks such as running a pump, or turning a shaft of an electric generator. Wind turbines can be grouped based on the orientation of their power shaft. Wind turbines with their power shafts oriented vertically are known as vertical-axis wind turbines and those with their power shafts oriented horizontally are known as horizontal-axis wind turbines. Wind turbines can also be grouped by the mechanism in which they extract energy from the wind. Wind turbines that extract energy from the wind by lift force are designated as lift-type wind turbines. Those that extract energy by drag force are known as drag-type wind turbines. There are also wind turbines that extract energy by both lift and drag force mechanisms and are known as hybrid wind turbines.

There are numerous vertical-axis wind turbines that control the orientation of blades in a00n attempt to maximize the efficiency of the energy extraction. U.S. Pat. Nos. 8,414,266; 8,382,435; 8,206,106; 8,164,213; 6,929,450; 6,619,921; 5,083,902; 4,818,180; 3,810,712; 185,924 and U.S. Patent Publication No. 2010/0232960 disclose mechanisms for changing the orientation of the blades to be vertical when rotating with the wind and to flatten out when rotating against the wind.

### SUMMARY OF THE INVENTION

The present invention provides a motion-translation mechanism for rotating blades of a vertical-axis wind turbine. The mechanism has a power shaft mounted for rotation about a first axis of rotation oriented vertically. Two or more axles are mounted for rotation about the first axis, each axle having a second axis of rotation extending longitudinally therethrough and transverse to the first axis. Each axle has a first end and a second end opposed to the first end, the first end being connected to the power shaft and the second end having a blade holder. A surface is mounted circumjacent the power shaft and is axially spaced from the two axles. There is a connector arm assembly for each axle coming off of the main power shaft. Each connector arm assembly connects the blade holder to the surface. The shape of the surface defines the path of each of the connector arms as each connector arm assembly rotates radially about the surface while maintaining connection to the blade holder. Each connector arm has a third end and a fourth end opposed to the third end. The third end being connected to its associated blade holder, the fourth end being in cooperative engagement with the surface. Each fourth end moves from a maximum vertical displacement to a minimum vertical displacement then from a minimum vertical displacement to a maximum vertical displacement during a single rotation of the power shaft thus causing the blade holders along with the attached blades to rotate positive 90° then negative 90 degrees about the second axis of rotation.

### BRIEF DESCRIPTION OF THE DRAWINGS

FIG. 1 is an isometric, exploded view of an embodiment of the present invention;

FIG. 2 is and isometric, enlarged view of section A of FIG. 1;

FIG. 3 is a top plan view of the wind turbine of FIG. 1;

FIG. 4 is a front elevation view in partial cross-section of a portion of the embodiment of FIG. 1;

FIG. 5 is an isometric view of an energy translation assembly with angled ramps positioned 180° apart;

FIG. 6 is a top plan view of the energy translation assembly of FIG. 5;

FIG. 7 is a side elevation view of the energy translation assembly of FIG. 5;

FIG. 8 is an isometric view of a portion of the translation assembly of FIG. 5;

FIG. 9A is an isometric view of another embodiment of an energy translation assembly;

FIG. 9B is a top plan view of the energy translation assembly of FIG. 9A;

FIG. 10A is an isometric view of an energy translation assembly with angled ramps positioned 150° apart;

FIG. 10B is a top plan view of the energy translation assembly of FIG. 10A;

FIG. 11A is an isometric view of an energy translation assembly with angled ramps positioned 120° apart;

FIG. 11B is a top plan view of the energy translation assembly of FIG. 11A;

FIG. 12A is an isometric view of an energy translation assembly with angled ramps positioned 90° apart;

FIG. 12B is a top plan view of the energy translation assembly of FIG. 12A;

FIG. 13 is an isometric view of a connector arm assembly;

FIG. 14 is a front elevation view of the connector arm assembly of FIG. 13;

FIG. 15 is an exploded view of a connector arm assembly;

FIG. 16 is an isometric view of a blade assembly;

FIG. 17 is an isometric view of a vertical-axis wind turbine with a wind vane;

FIG. 18 is an isometric view of another embodiment of a custom track vertical-axis wind turbine;

FIG. 19 is a side elevation view of the wind turbine of FIG. 18 showing one blade in a maximum wind capture position and another blade in a minimum drag position;

FIG. 20 is an enlarged view of a portion of the wind turbine of FIG. 18;

FIG. 21 is a side elevation view in partial cross-section of the wind turbine of FIG. 18;

FIGS. 22A,B is a side elevation view of a roller coaster assembly and roller coaster support assembly and an exploded view of the same, respectively;

FIGS. 23A,B is a side elevation view of a blade assembly and an exploded view of the blade assembly respectively;

FIGS. 24A,B is an isometric view of a blade connector assembly and an exploded view of the blade connector assembly respectively;

FIG. 25 is an isometric view of another embodiment of a custom track vertical-axis wind turbine;

FIG. 26 is a side elevation view of the wind turbine of FIG. 25 showing one blade in a maximum wind capture position and another blade in a minimum drag position;

FIG. 27 is an enlarged view of a portion of the wind turbine of FIG. 25;

FIG. 28 is a side elevation view in partial cross section of the wind turbine of FIG. 25;

FIGS. 29A,B is an isometric view of a roller coaster support assembly and an exploded view of the same respectively;

FIGS. 30A,B is an isometric view of a roller coaster assembly and an exploded view of the roller coaster assembly respectively;

FIGS. 31A,B is an isometric view of a blade connector arm assembly and an exploded view of the blade connector arm assembly respectively;

FIGS. 32A,B is an isometric view of a track assembly and an exploded view of the track assembly respectively;

FIG. 33 is an isometric view of an interior portion of second principal embodiment of a vertical-axis wind turbine;

FIG. 34 is an exploded view of the second principal embodiment of a vertical-axis wind turbine;

FIG. 35 is a side elevation view of a base assembly of the second principal embodiment;

FIG. 36 is a SolidWorks model isometric view of a blade rotating about the vertical axis in the second principal embodiment;

FIG. 37 is a SolidWorks model isometric view of a blade rotating about the vertical axis in the first principal embodiment;

FIG. 38 is a SolidWorks model front view of a blade rotating about the vertical axis in the second principal embodiment;

FIG. 39 is a SolidWorks model front view of a blade rotating about the vertical axis in the first principal embodiment;

FIG. 40 is a SolidWorks model surface area breakdown for power generation in the second principal embodiment;

FIG. 41 is a SolidWorks model surface area breakdown for power generation in the first principal embodiment;

FIG. 42 is a chart of torque vs. efficiency for blades of varying lengths for the second principal embodiment;

FIG. 43 is a chart of torque vs. efficiency for blades of varying lengths for the first principal embodiment; and

FIG. 44 is a SolidWorks isometric view of a stacked turbine having two vertically spaced wind turbines associated with a single axle.

### DETAILED DESCRIPTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

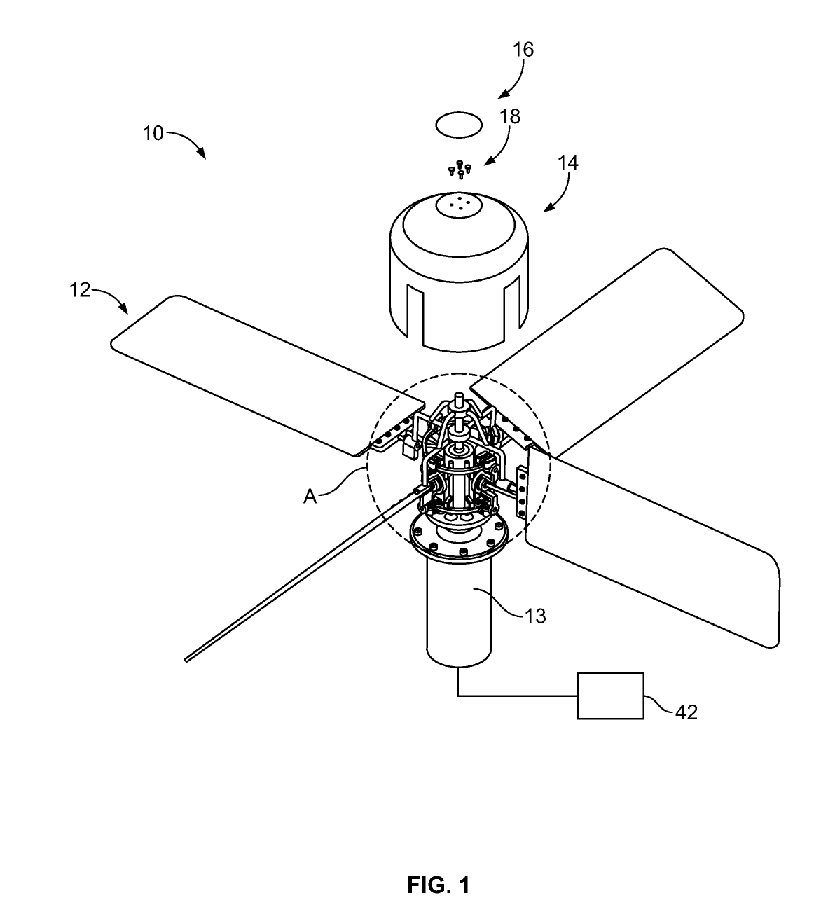

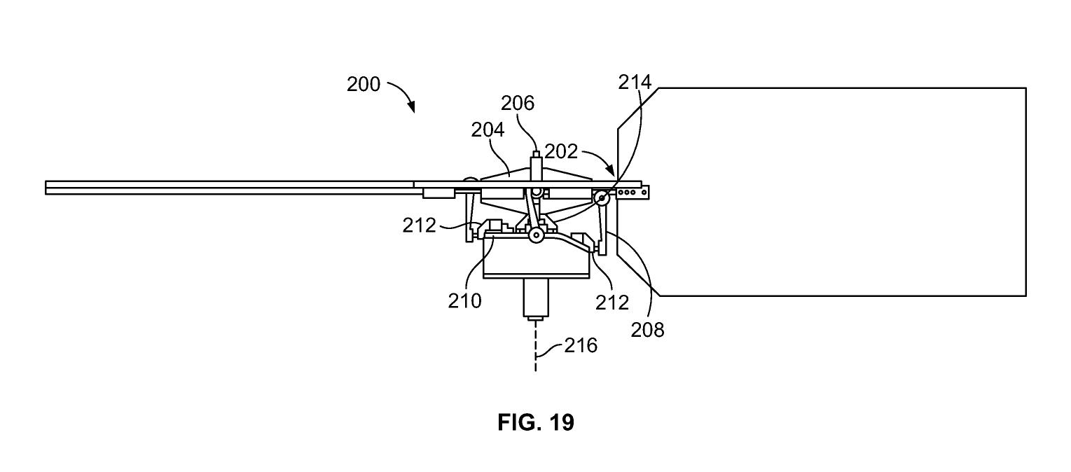

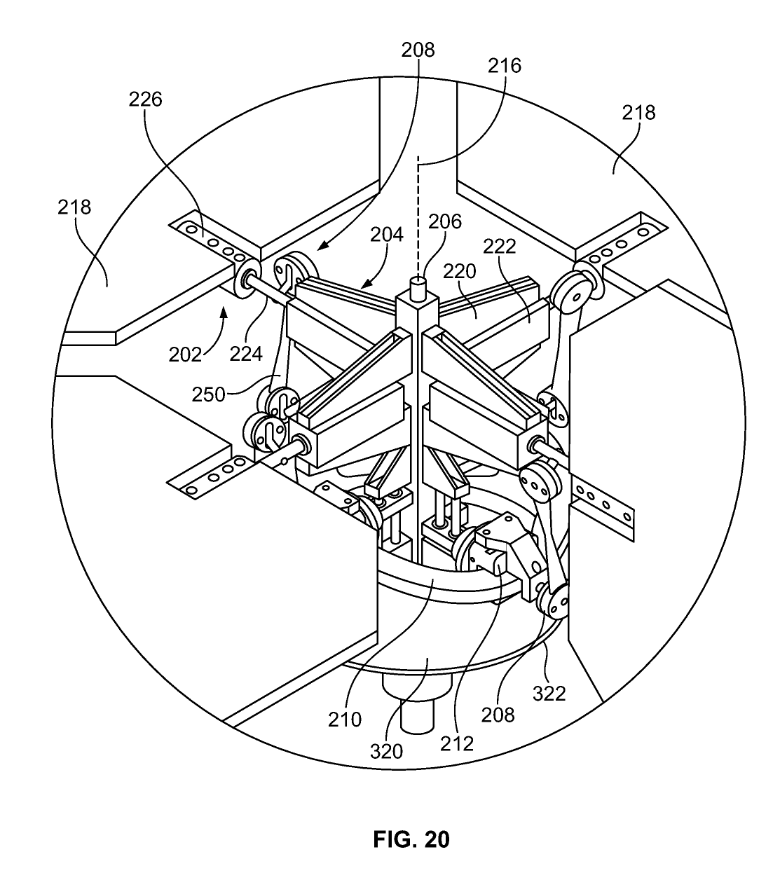

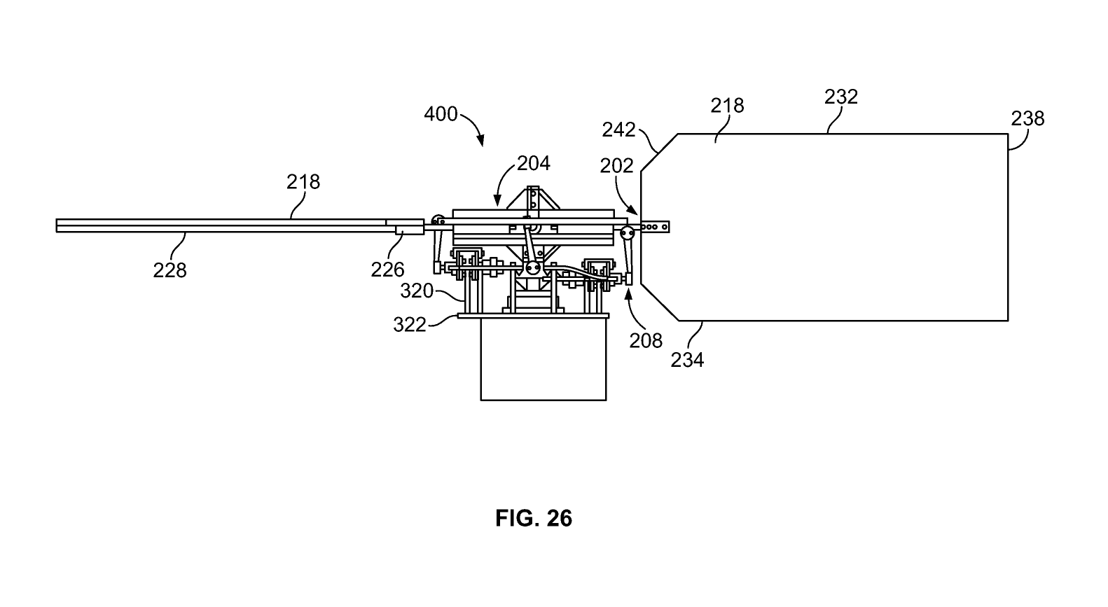

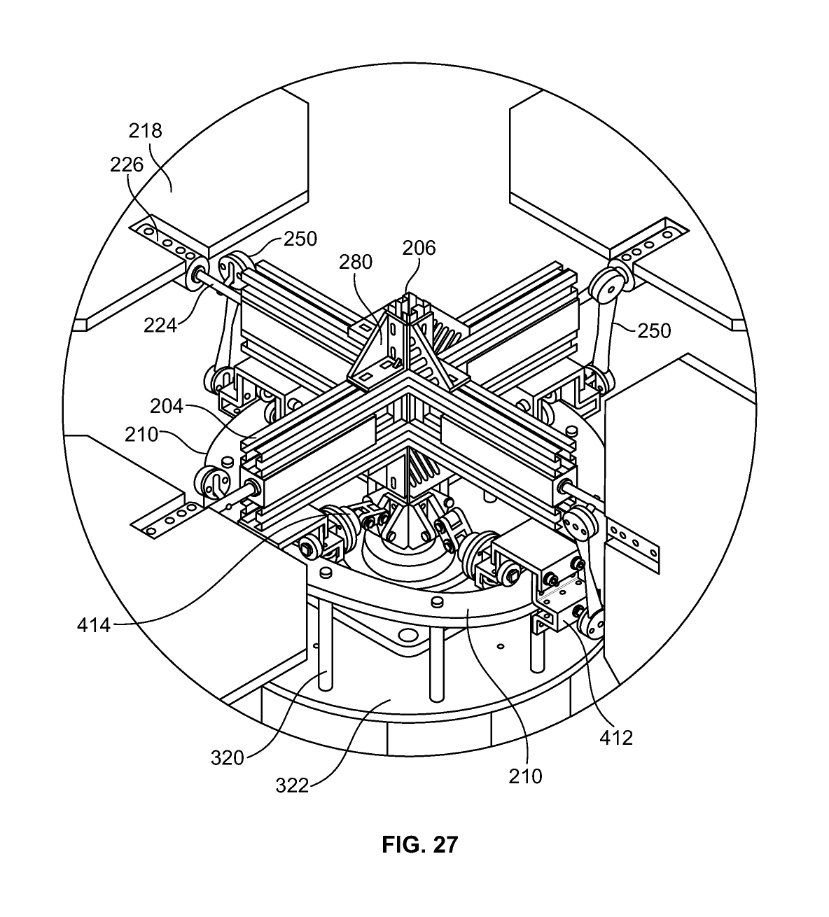

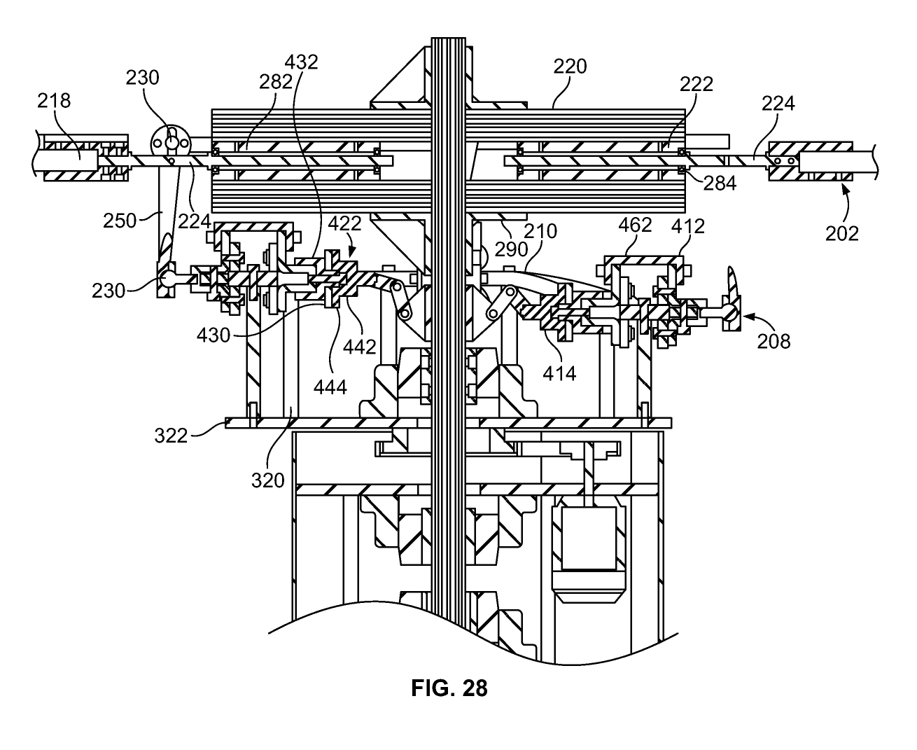

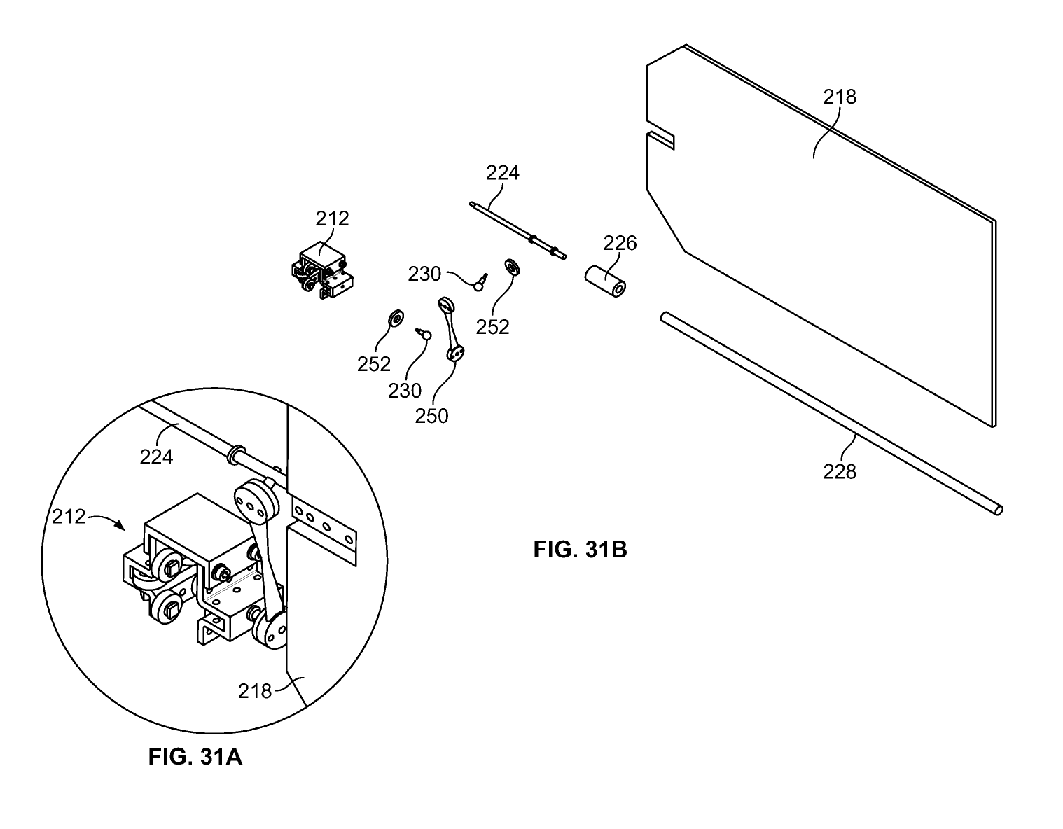

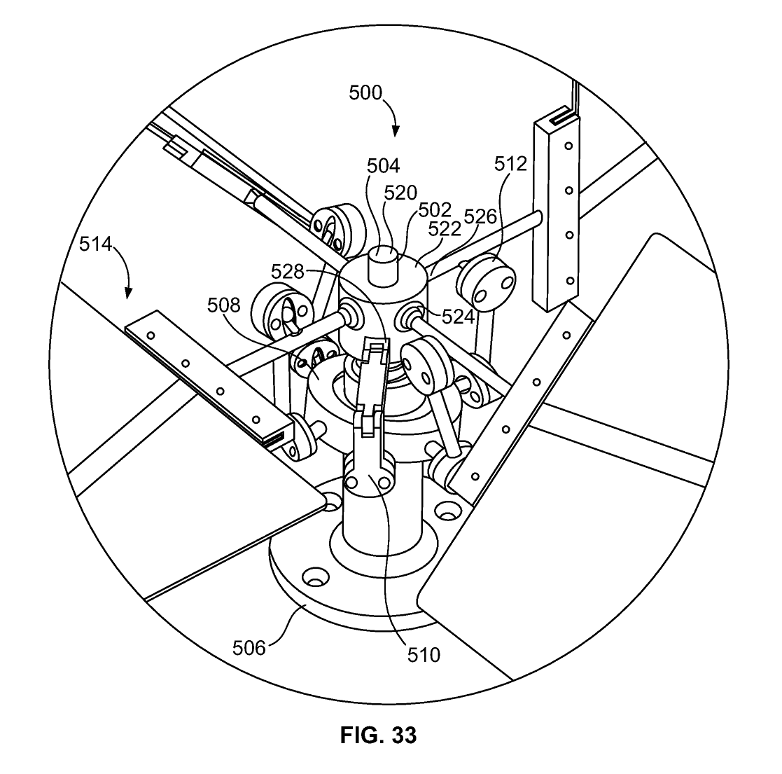

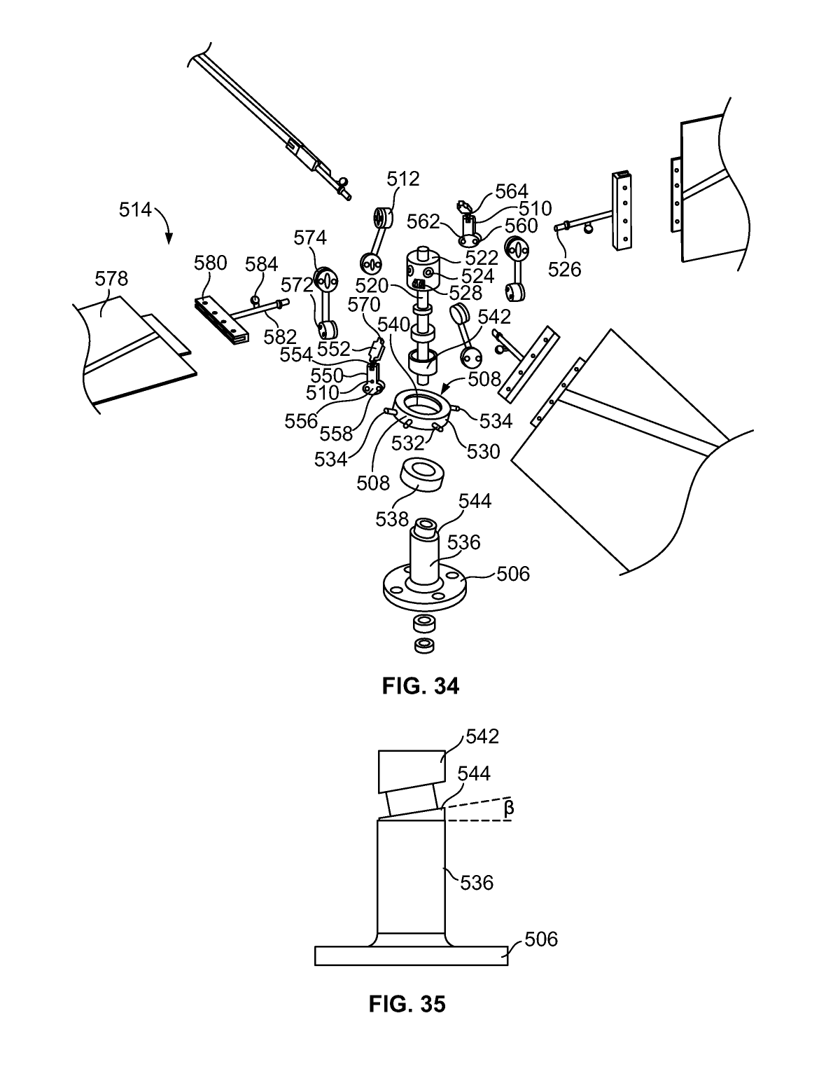

The present invention provides a vertical axis wind turbine having two principal embodiments. Variations of the first principal embodiment are shown in FIGS. 1-32B and sometimes may be referred to as the custom track embodiment. The second principal embodiment is shown in FIGS. 33-44 which will sometimes be referred to as the wobble assembly or the circular track embodiment. The first principal embodiment utilizes a custom track roller coaster system and the second principal embodiment utilizes a surface mounted for rotation about an axle disposed at an angle to the vertical. Computer-assisted modeling of these embodiments shown in the Examples set forth below indicate that the second principal embodiment, while being much simpler in design and construction, is less efficient than the custom track design in converting wind energy into power. While not wanting to be bound by any particular theory, the efficiency differences are thought in part to be attributable to the lack of control over the timing of the blade rotation in the second principal embodiment so the gradual blade rotation produces additional drag that can otherwise be eliminated with a custom track system. The custom track design allows for precise timing of blade rotation to maximize positive wind capture while minimizing the exposed blade surface area exposed to drag.

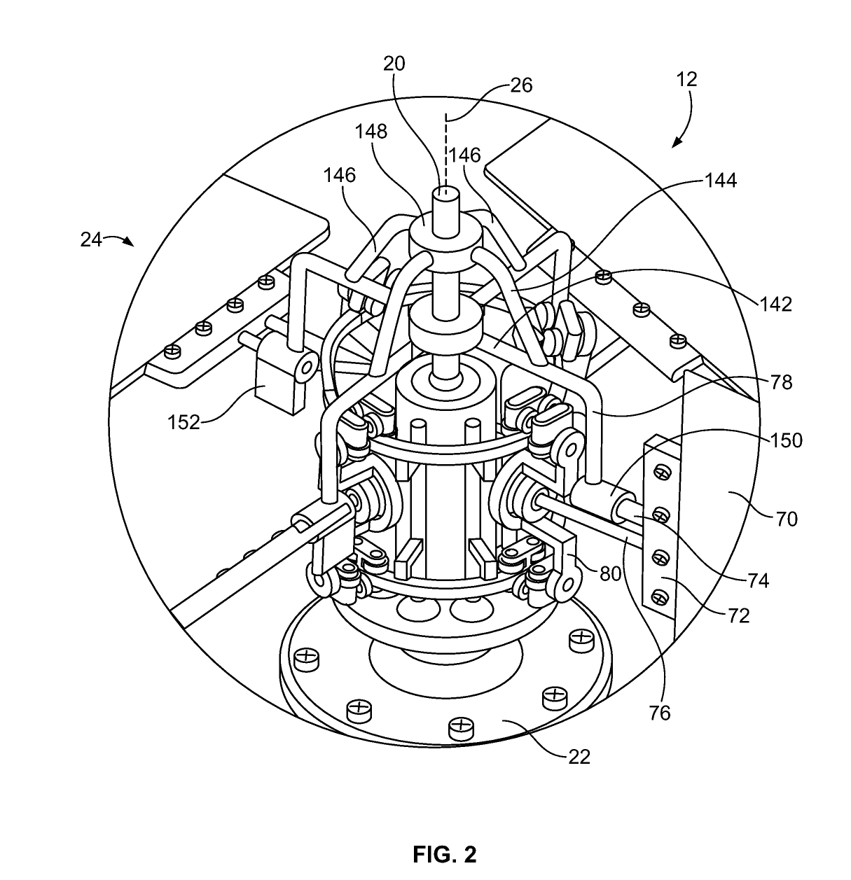

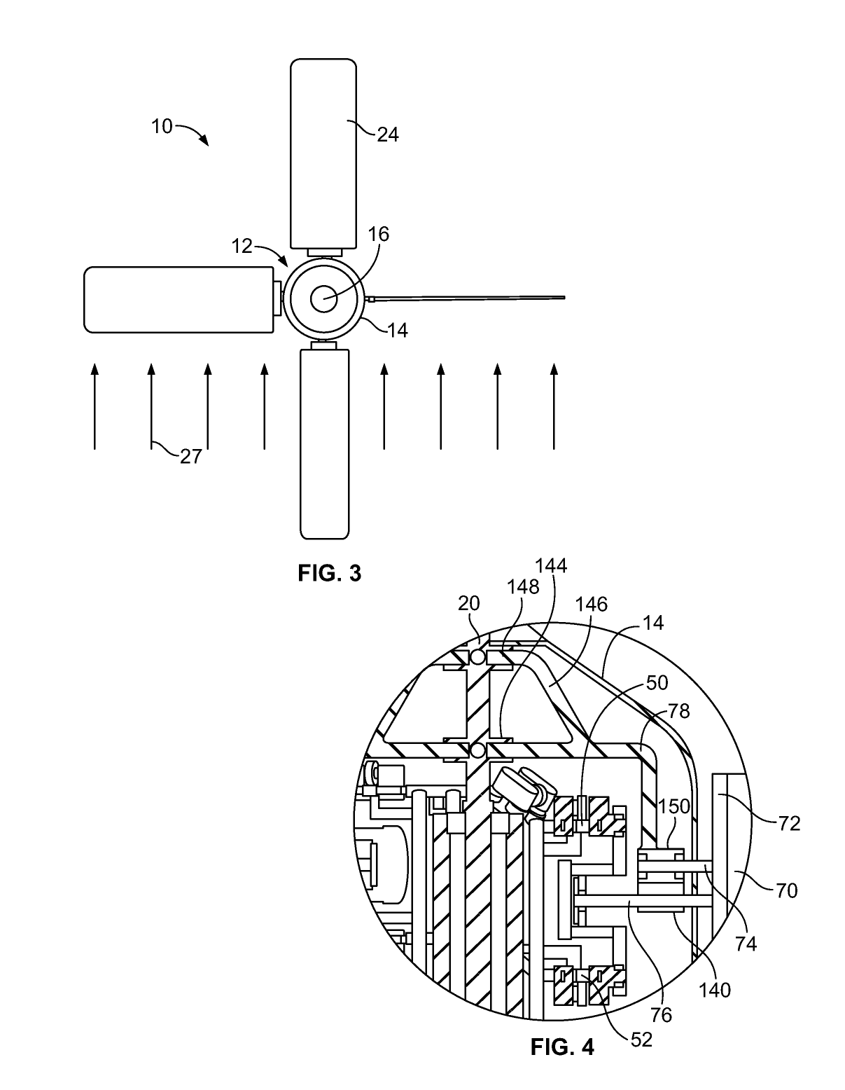

FIG. 1 shows one form of the first principal embodiment of a vertical-axis wind turbine 10 having a main assembly 12, a motor housing 13, a protective cover 14, a top cover 16 and screws 18 for securing the protective cover to the main assembly. FIG. 2 shows the main assembly 12 having a main power shaft 20, an energy translation assembly 22, and blade assemblies 24 mounting blades to the power shaft 20 and the energy translation assembly 22. The power shaft 20 is mounted for rotation about vertical axis 26 together with the blade assemblies 24 when the blades are exposed to wind 27 as shown in FIG. 3.

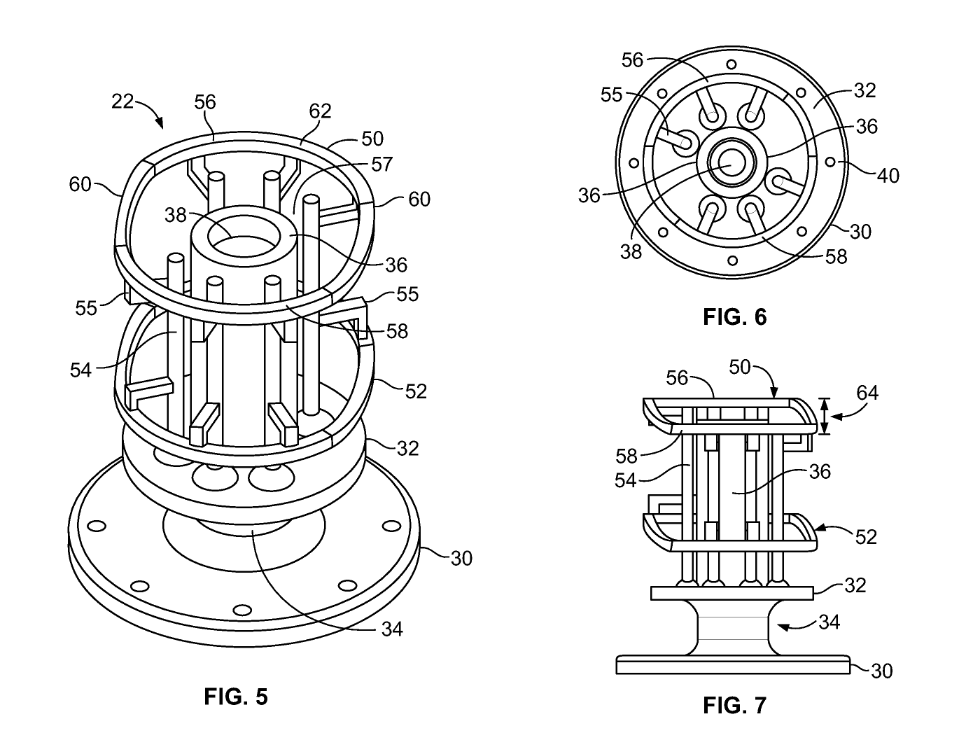

As best seen in FIGS. 5-12B, the energy-translation assembly 22 has a base support plate 30, a track support plate 32 concentrically disposed with respect to the support plate 30 but having a smaller diameter. The track support plate 32 is mounted to the support plate 30 by a centrally disposed column 34. A cylindrical pipe 36 defining a lumen 38 dimensioned to receive and mount the power shaft 20 is centrally disposed on the track support plate 32 and is attached thererto. The lumen 38 is in communication with a through hole 40 extending through the support plate 30, the column 34, and the track support plate 32 and forms a passage for the main power shaft 20 to an energy capture or utilization mechanism 42 such as a pump or electrical generator (FIG. 1).

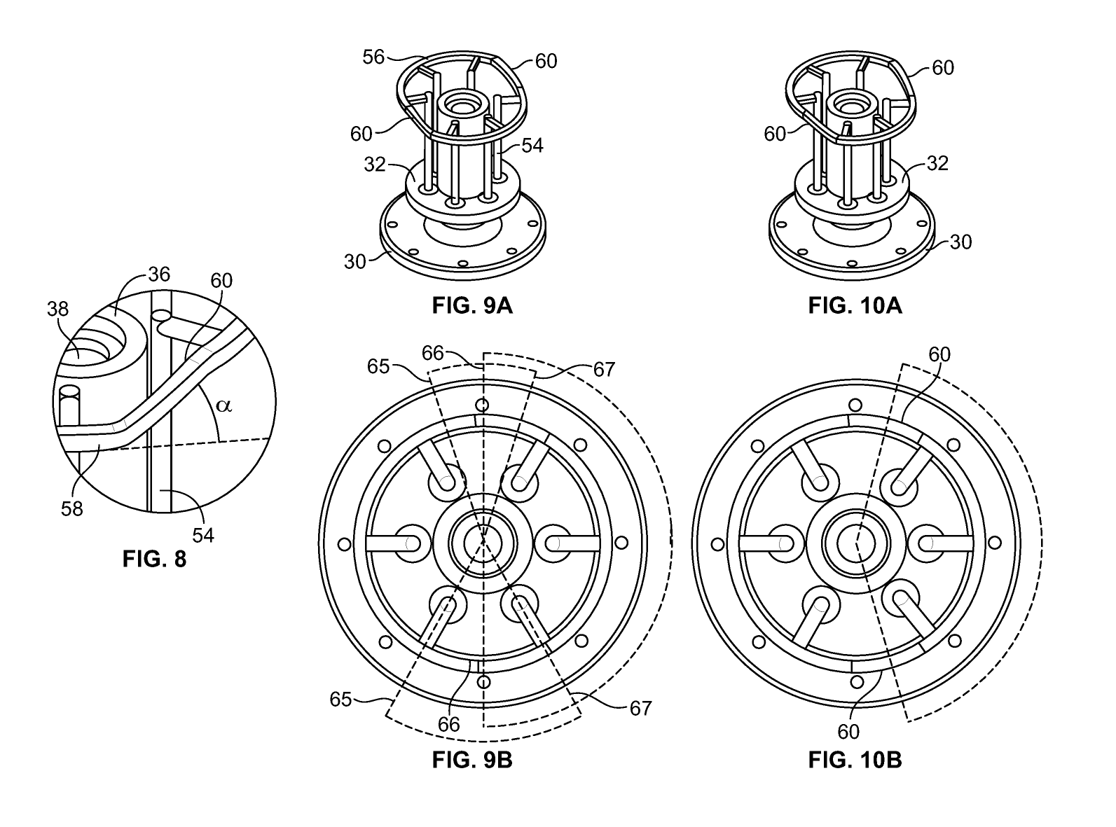

An upper track 50 and a lower track 52 are mounted to the track support plate 32, by support columns 54, and generally L-shaped brackets 55. Each track is circuitous and extends circumjacent the pipe 36, the power shaft 20 and is radially spaced therefrom to form an annular channel 57. Each of the upper and lower tracks 50, 52 each have a first arcuate section 56, a second arcuate section 58 and two arcuate sections 60 connecting opposed ends of the first and second arcuate sections 56, 58. The first and second arcuate sections 56, 58 have an upper surface 62 that extends generally parallel to a horizontal line that is perpendicular to the first axis of rotation 26. The first and second arcuate sections are axially spaced by a distance referred to as 64 in FIG. 7. FIG. 8 shows the connecting arcuate sections 60 slope downwardly from the first section to the second section and define a plane that intersects the first axis of rotation at an angle a that is from about 5° to about 60° and more preferably about 30°, or any range or combination of ranges therein. It is contemplated that the lower track 52 could be eliminated without departing from the present invention and as described below as alternative forms of the first principal embodiment.

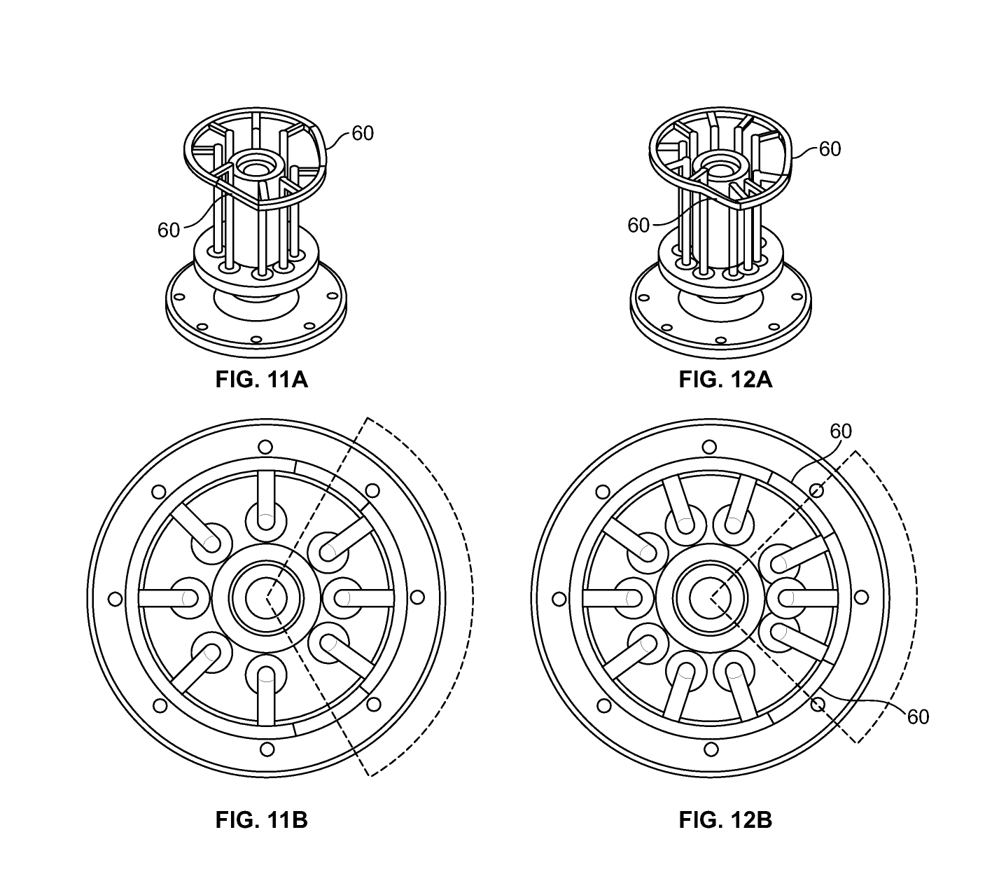

The middle of the connecting arcuate sections 60 are shown in FIGS. 5 and 9A,B are separated by 180°. FIGS. 9A,B show a first arc region extending between lines 65-65 where the blades are fully horizontal when the connector arm assemblies 70 are in this region. When the connector assemblies are in a second arc region between lines 65-66, the blades are moving between horizontal and a 45° orientation to the horizontal. When the connector assemblies are between lines 67-67 the blades are vertical. While the middle points of the two connecting arcuate sections 60 are shown 180° apart, it is contemplated the middle points of the two connecting arcuate section 60 can be separated from about 90° to about 180°. FIGS. 10A,B show, for example, the middle points of the connecting arcuate sections separated by 150°, FIGS. 11A,B show a 120° separation, and FIGS. 12A,B show a 90° separation.

FIG. 2 shows four blade assemblies 24 each having a blade 70, a blade holder 72, a blade holder support axle 74, a blade holder lever axle 76, a blade support arm assembly 78, and a roller coaster assembly 80. The blade support arm assembly 78 connects the blade holder 72 to the power shaft 20 so that they rotate about axis 26 together. The roller coaster assembly 80 connects the blade to the energy translation assembly 22 such that vertical displacement of the roller coaster assembly 80 rotates the lever axle 76 about its own axis of rotation to move the blades from vertical to horizontal positions.

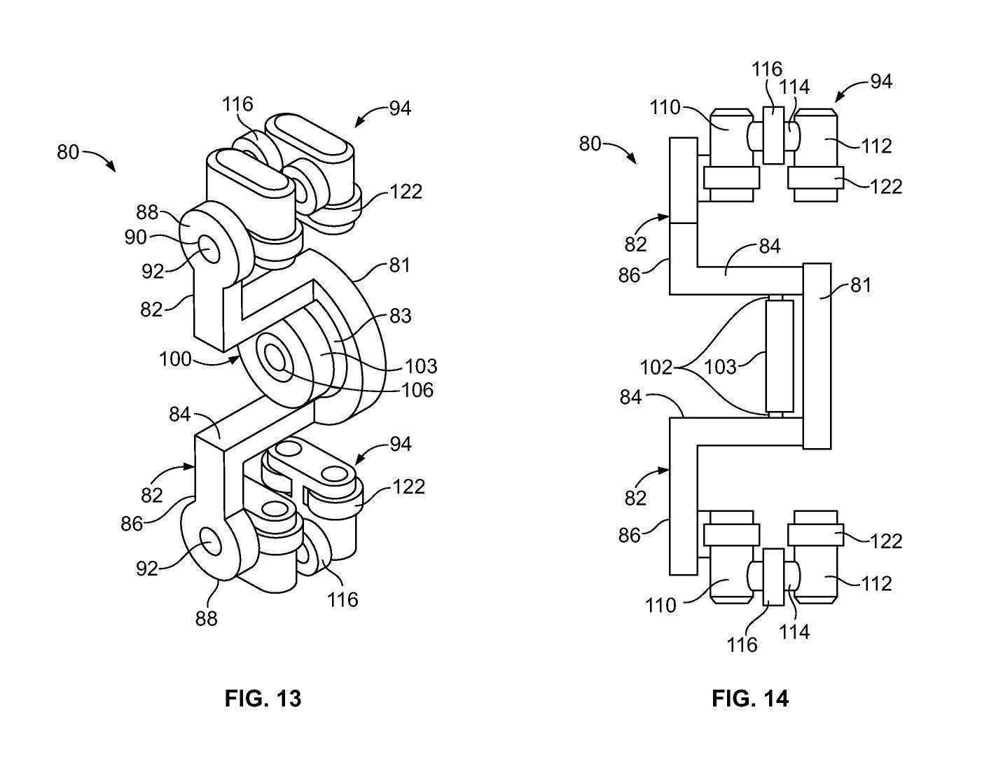

FIGS. 13 and 14 show a roller coaster assembly having a generally circular ring 81 and two L-shaped arms 82 extending radially from an inner surface of the ring 81 and circumferentially spaced from one another by about 180°. The ring 81 defines a central opening 83 having an axis of rotation. Each L-shaped arm 82 has a radially directed segment 84 and an axially directed segment 86 extending away from the ring 81. The axially directed segment 86 terminates in a circular head 88 with a centrally disposed through hole 90. A bearing assembly 93 positioned in the through hole 90 and journals an axle 92 of a wheel assembly 94 for rotation of the wheel assembly about the axle 92.

FIGS. 13-15 also show the roller coaster assembly 80 has a swivel bearing assembly 100 mounted by pins 102, extending from opposed surfaces of each of the radially directed segments 84. The swivel bearing 100 has a circular wall 103 having a central opening 104 generally concentrically disposed from the central opening 104 and spaced axially therefrom. The central opening 104 houses a bearing cup 106 for journaling the lever axle 76 of the blade 70.

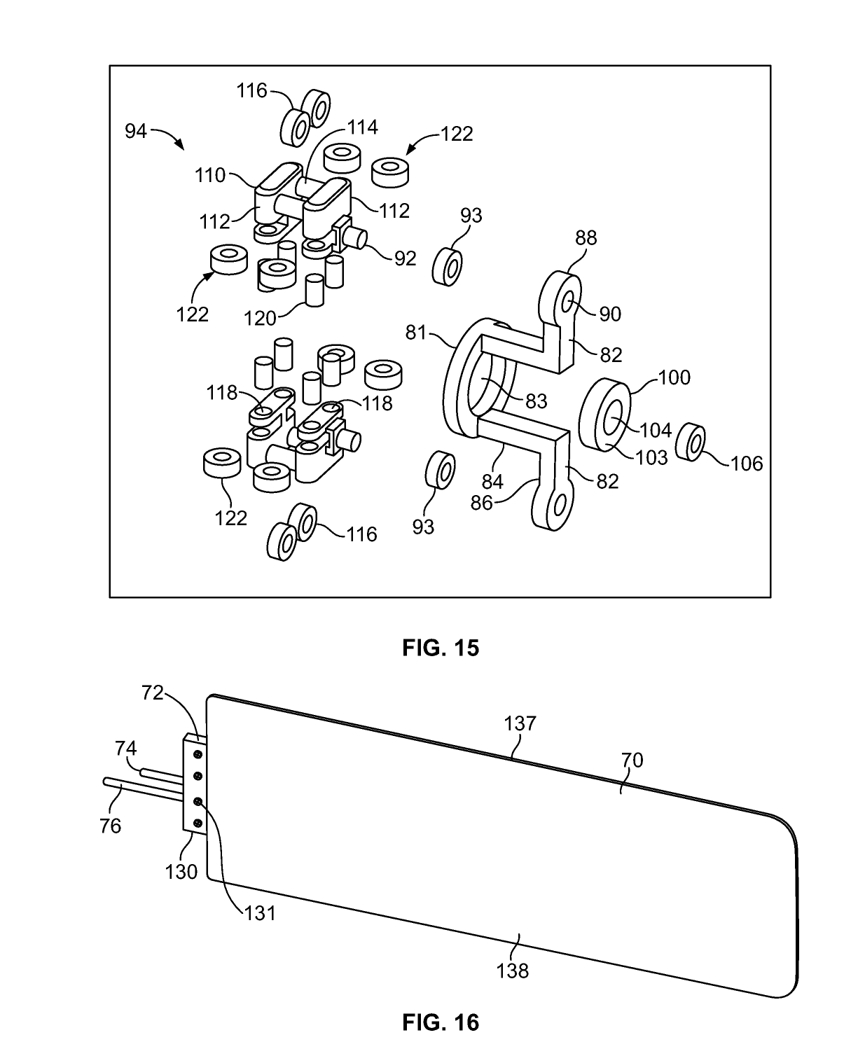

As best seen in FIG. 15, each wheel assembly 94 has a housing 110 having two generally rectangular shaped bodies 112 joined together by two horizontal axles 114 which mount two wheels 116 in tandem arrangement. Each of the rectangular shaped bodies 112 have cylindrically shaped chambers 118 for receiving four vertical axles 120 journaling four wheels 122. The two wheels 116 engage a planar surface of tracks 50, 52. In the case of the upper track 50 the two wheels 116 engage an upper planar surface and in the case of the lower track 52 the two wheels 116 engage a lower planar surface. Two of each of the four wheels 122 engages opposed outer surfaces of the upper and lower tracks 50, 52. The roller coaster assemblies 80 rotate about the power shaft in response to wind currents hitting the blades 70 to move along the upper and lower tracks from a maximum vertical displacement when in contact with the first arcuate segment 56 to a minimum vertical displacement when in contact with the second arcuate segment 58. If only one track is used, the connector arm would be modified to eliminate one of the L-shaped arms and wheel assemblies and the connector arm would have the ring 81 as one end of the connector arm.

FIG. 16 shows a blade 70 and a blade holder 72 attached to an edge of the blade 70. The blade holder has a first plate 130 joined by four screws 131 to a second plate 132 to define a generally U-shaped channel 134 for receiving and securing to a tab extending from an edge of the blade 70. Lever axle 76 and axle 74 extend radially from the blade holder 72 in a direction opposite of the blade. As set forth above, axle 76 is journaled in the central opening 104 and provides leverage to rotate the blade about axle 74 in response to vertical movement of the roller coaster assemblies 80. Axle 74 is connected to blade support arm assembly 78 which in turn is connected to the main power shaft 20.

The blade 70 has a leading edge 137 and a trailing edge 138 and the leading edge has a tapered surface that reduces the thickness of the blade when compared to the trailing edge. The blade is fabricated from a lightweight yet rigid material such as balsa wood, fiberglass, carbon fiber, or plastic.

As shown in FIGS. 2 and 4, blade support arm assemblies 78 have a first end having a bearing assembly 140 and a second end for mounting to a first coupling collar 144 fixedly attached to the power shaft 20. In one preferred form of the invention, the blade support arm assembly 78 has a supplemental arm 146 for connecting to a second coupling collar 148 connected to the power shaft 20 and spaced axially above the first coupling collar 144. The bearing assembly 140 has a generally cylindrical body 150 having an internal chamber containing a bearing assembly for receiving the axle 74. The cylindrical body 150 has a flange 152 extending tangentially from an outer peripheral surface. The flange 152 acts as a stop for the axle 76 when a blade 70 is in a full vertical position.

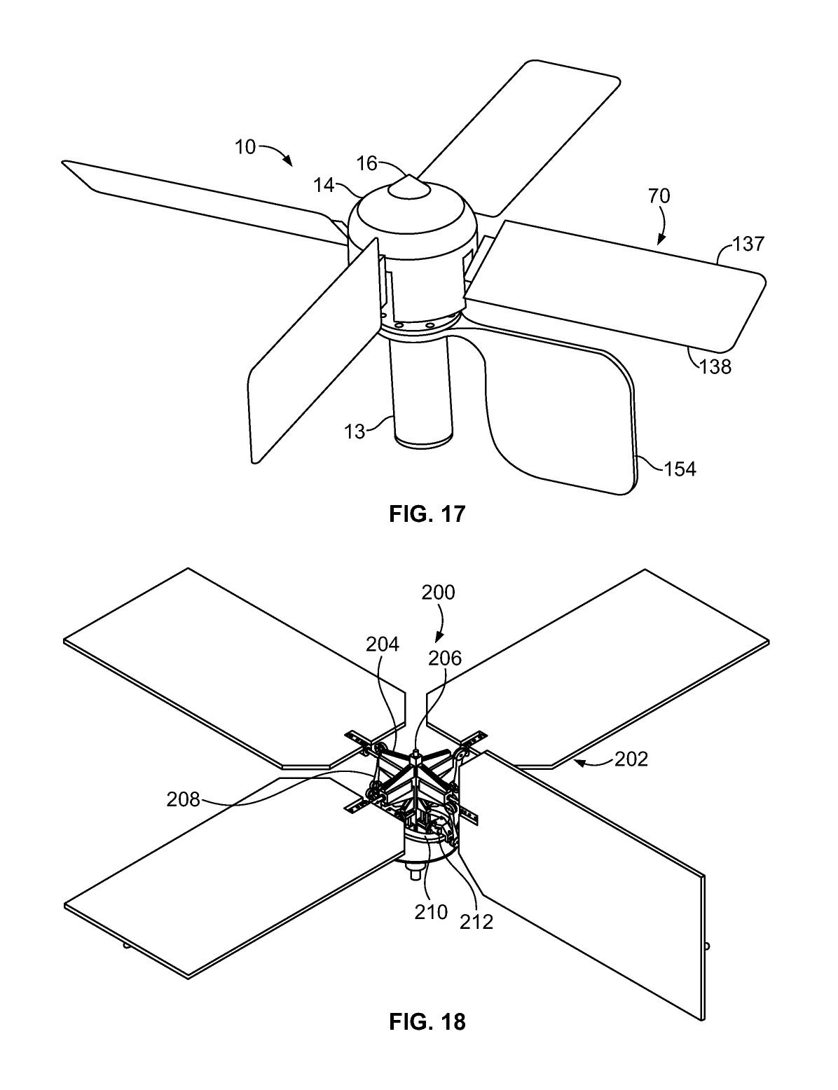

FIG. 17 shows the vertical-axis wind turbine having a wind vane 154 to orient the assembly 12 into the wind so that when a blade is in a full vertical position it is perpendicular to the direction of the wind and the blades are rotating about the axis 26 with the wind.

The vertical-axis wind turbine 10 shown in FIGS. 1-17 operates as follows. While the operation will be described for a four blade embodiment, it should be understood that any number of blades, even or odd, could be used but preferably from 2 to 16, more preferably 2 to 12, even more preferably 2-8 and most preferably 4 blades, or any range or combination of ranges therein. As the blades 70 are pushed by the wind they rotate counterclockwise about axis 26 together with the roller coaster assembly 80, the support arm assembly 78 and the power shaft 20. The connector is at the maximum vertical displacement when the arm is traversing along the first arcuate segment. At this point, both axles 76 and 74 and have the same vertical displacement and the blade is completely horizontal as the blade cuts through the wind. When the connector arm traverses a descending portion of the connecting arcuate segment 60, axle 76 is vertically lower than axle 74 and the leading edge of the blade 137 rotates upwardly about an axis of the axle 74. The connector is at the minimum vertical displacement when the roller coaster assembly traverses the second arcuate segment of the track, the axles 76 and 74 are both parallel to a horizontal and in vertical registration and the blade is in the full vertical position. As the roller coaster assembly traverses the ascending leg of the connecting arcuate segment 60, the leading edge of the blade 137 rotates downwardly about the axis of the axle 74.

Thus, in the four blade embodiment, there are two pairs of opposed blades. When a first pair of blades has one of its blades in a full vertical position, its opposed blade is in the full horizontal position. With a surface designed such that the upward sloping ramp and downward sloping ramp are located 180 degrees apart the second pair of blades will have both blades oriented 45 degrees to a horizontal. It should be noted, with the customizable surface embodiment the shape of the surface can be varied such that the angle between the upward and downward portions of the track is increased or decreased in order to rotate the blades into and out of the wind at specific times in order to increase wind capture efficiency. When the power shaft rotates about the axis 26 through the first 180° segment, the opposed blades will rotate in equal arc segments but in opposite directions about the axle 74. During the second 180° segment, the blades will rotate in opposite directions about axle 74 from the first 180° segment backward through the same arc segment. With a surface designed such that the upward sloping ramp and downward sloping ramp are located 180 degrees apart, it can be appreciated that each pair of blades will have one blade traveling up the track while the other blade is traveling down the track or both blades will be on a flat segment of the track. Thus, the blades are mounted in a “gravity neutral” arrangement and there are no losses associated with the rotating blades due to the weight of the roller coaster assemblies 80.

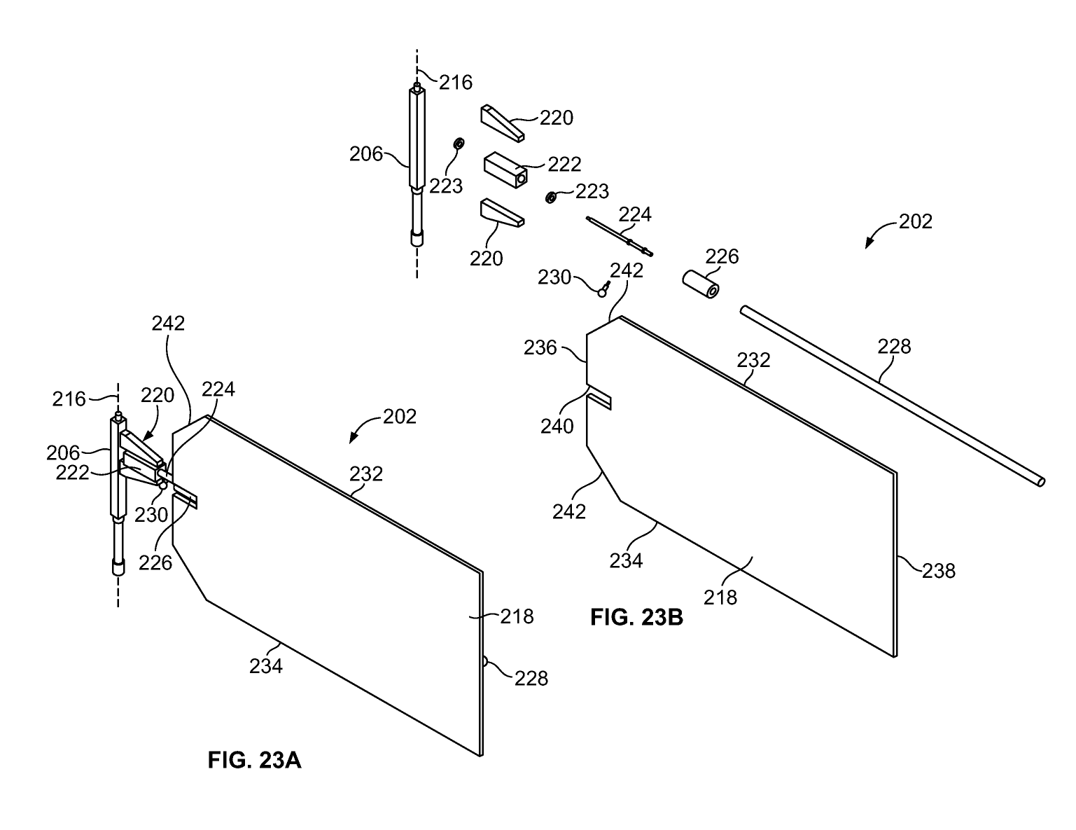

FIGS. 18-24B show another form 200 of the first principal embodiment having a blade assembly 202, a blade-arm support assembly 204 connecting the blade assembly 202 to a main power shaft 206, a connecting arm assembly 208, a track 210, a roller coaster assembly 212, and a roller coaster support assembly 214 for connecting the roller coaster assembly 212 to the power shaft 206 for co-rotation about an axis 216 of the power shaft 206. In a preferred form of the invention, three of the blades will be in a full horizontal position when one blade is in a full vertical position. FIGS. 23A,B show the blade assembly 202 having a blade 218, a blade arm structural support 220, a blade arm rotational hub 222 mounting a bearing 223, a blade arm 224, a blade holder 226, a blade spine 228, and a spherical arm 230. In one preferred form of the invention, an axial portion of the power shaft 206 will have a generally square-shaped cross-sectional shape providing four flat surfaces to mount the four blade assemblies 202. The blade arm rotational hub 222 is mounted to the power shaft 206 by an opposed pair of the blade arm structural supports 220. The blade arm structural supports 220 are shaped like an isosceles right triangle with a short leg, a long leg and a hypotenuse. An edge of each of the short legs are mounted to the shaft and are axially spaced from one another by a gap and are disposed at 180 degrees from one another about a longitudinal axis of the gap. In this orientation the long legs form upper and lower surfaces adjacent the gap. The rotation hub is positioned in the gap where it is sandwiched between the upper and lower surfaces and retained by compressive forces or other fashion. The rotational hub journals the blade arm 224 for rotation about an axis of the blade arm. A portion of the blade arm extends from the rotational hub and a distal end connects or is connected to the blade holder 226. One end of the spherical arm 230 has a set of threads for connecting to the blade arm 224, intermediate the rotational hub and the blade holder, in a threaded notch 231, which in turn, connects the blade assembly 200 to a connector arm as discussed below.

The blade 218 is generally rectangular in shape and has a leading edge 232, a trailing edge 234, a proximal edge 236, and a distal edge 238. In one preferred form of the invention a notch 240 is removed from the proximal edge and is dimensioned for receiving the blade holder. Additionally, in one preferred form of the invention an upper and lower portion of the proximal edge is beveled 242. The blade spine 228 supports the blade and attaches to a central portion of the blade and extends from the proximal edge to the distal edge and at a proximal end connects to the blade holder.

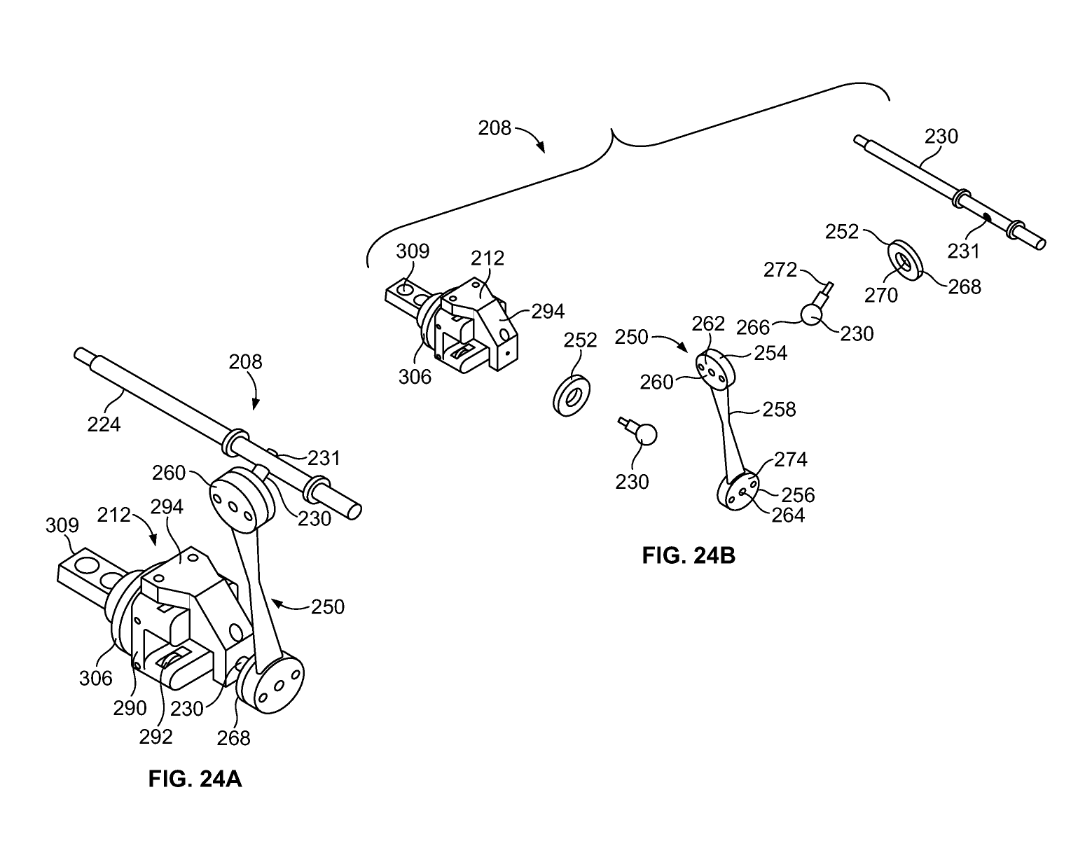

FIGS. 24A,B show the connecting arm assembly 208 having a connector arm 250, connector arm cover plates 252 and a roller coaster assembly 212. The connector arm has first and second opposed ends 254, 256 connected by a bar 258. The first end 254 has a generally oval shaped head 260 having a first inner face 262 having a generally centrally disposed socket 264 for contacting a spherical surface 266 on one end of the spherical arm 230. The cover plate 252 has an annular surface 268 circumjacent a central opening 270. The cover plate is fastened to the inner face 262 by threaded fasteners retaining the spherical surface of the spherical arm in the chamber with the connecting end 272 of the spherical arm 230 extending through the opening 270. The second end 256 has an oval shaped head having a second inner face 274 disposed at a 90° angle to the first inner face 262 and having a generally centrally disposed socket 264. A second spherical arm 230 connects the second face to the roller coaster assembly 212 in the same fashion.

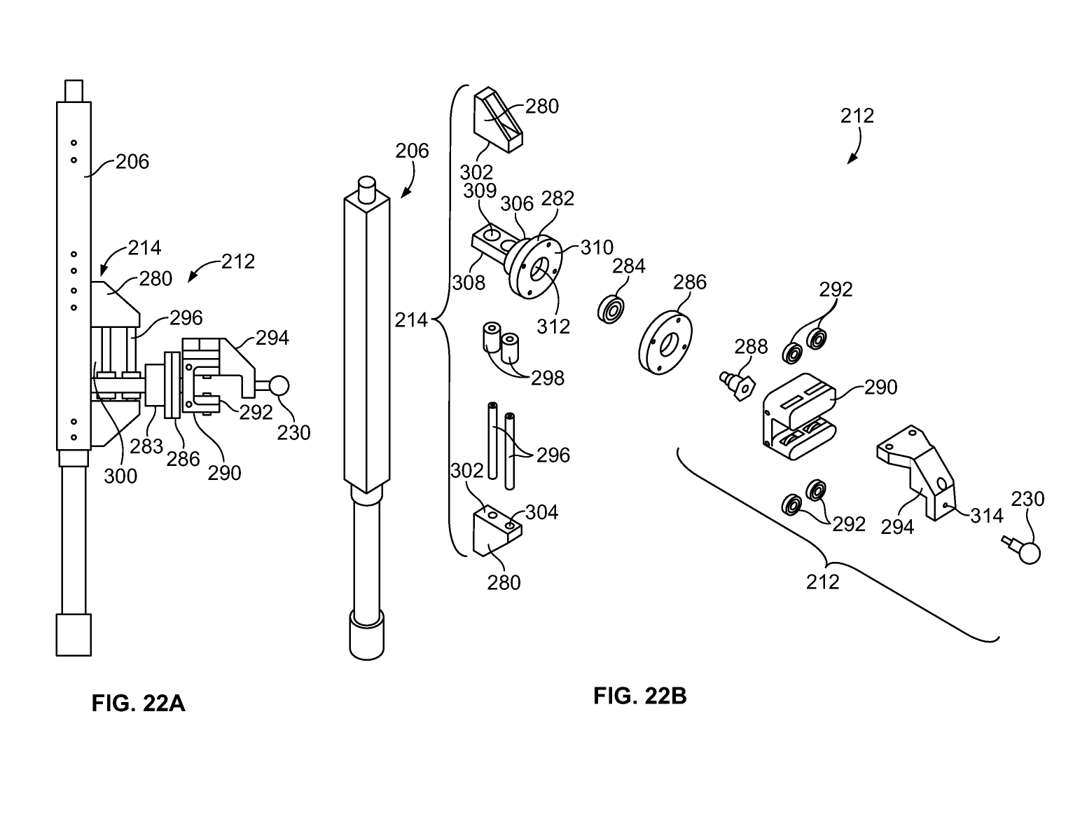

FIGS. 22A,B show the roller coaster assembly 212 and the roller coaster support assembly 214 connecting the roller coaster assembly 212 to the power shaft 206. The roller coaster support assembly 214 has a pair of linear guide supports 280, a linear support hub 282 mounting a ball bearing 284, a ball bearing capture plate 286, a ball bearing bolt 288, linear guide shafts 296, and linear bearings 298. The roller coaster assembly has a roller coaster hub 290, wheels 292, and a spherical arm support 294. The linear guide supports 280 each has an inner edge attached to the power shaft and are axially spaced from one another to define a gap 300. Facing edges 302 of each of the supports 280 have two radially spaced bores 304 along the surface with the bores on one support in vertical alignment with the bores of the other support and receive opposite ends of the linear guide shafts 296.

The linear support hub 282 has first and second ends with a first end having a generally cylindrically shaped body 306 and a second end of a flange 308 extending axially therefrom. The flange has two horizontally spaced through holes 309 for receiving a pair of linear bearings 298. The linear bearings slidingly engage the linear guide shafts to allow for reciprocal vertical movement of the roller coaster assembly from a top most position to a bottom most position corresponding respectively to a horizontal displacement of the blade to a vertical displacement of the blade. The first end of the hub has an annular flange 310 surrounding an opening 312 which is dimensioned to journal a bearing cup 284 held in place by a ball bearing capture plate 286 mounted to the annular flange 310 of the hub with the ball bearing bolt 288. The roller coaster hub 290 mounts four wheels 292 and is sandwiched against the linear support hub with a spherical support arm 294. The spherical support arm 294 is segmented and has opposed ends. A first end is attached to a top surface of the roller coaster hub 290 with a set of threaded fasteners and a second end provides a bore 314 for receiving the connecting end 272 of the spherical arm 230 of the connector arm assembly 208.

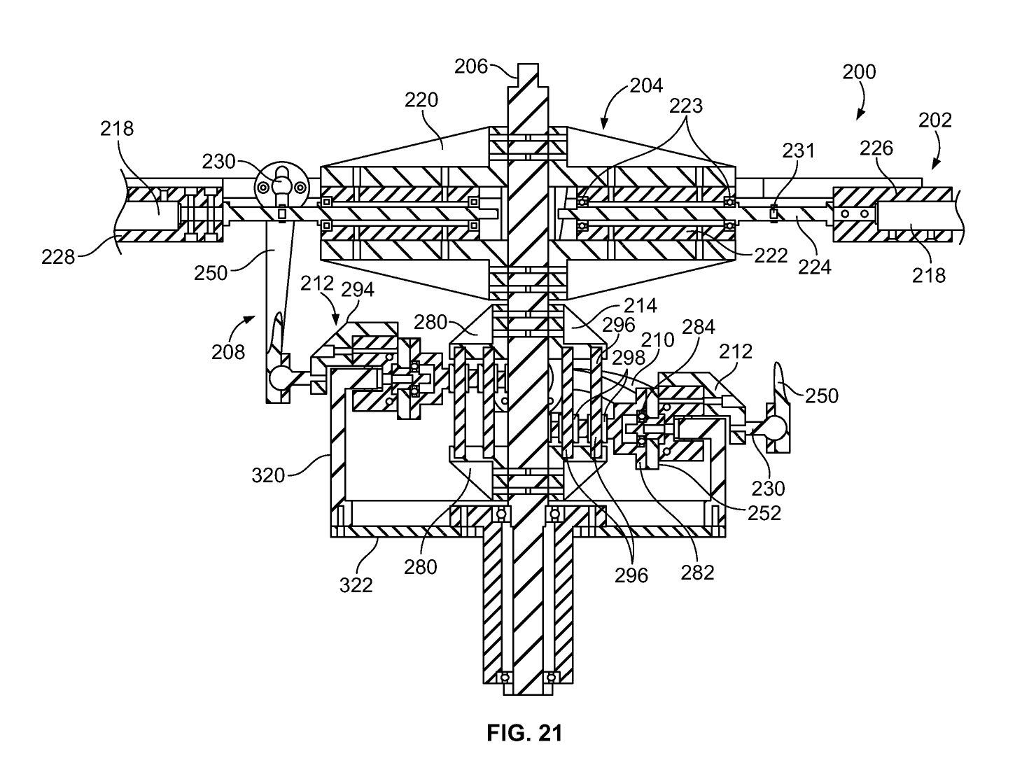

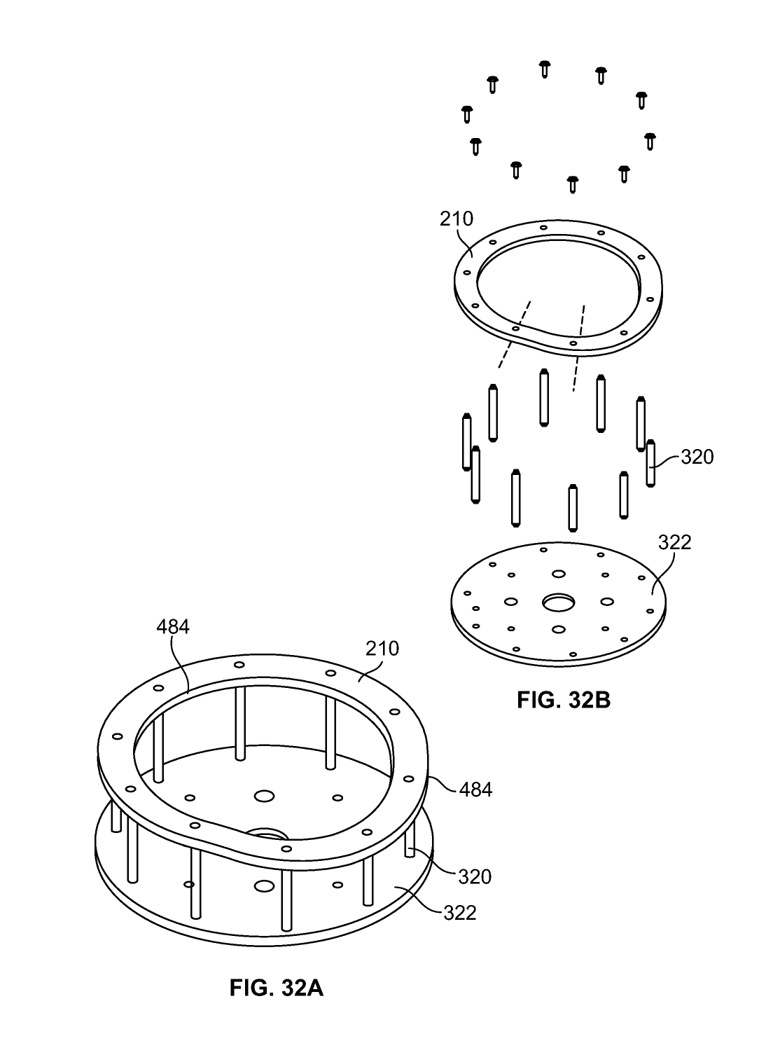

FIG. 21 shows the roller coaster assembly 212 engages a surface of the track 210. As with the other tracks discussed herein, the track 210, as shown in FIGS. 32A,B, has a continuous surface supported by a plurality of vertical track supports 320 extending from a track base 322. The track surface has a high point and a low point, with respect to the track base, and transitions between them. When a roller coaster assembly is in the high point, the corresponding blade is in a horizontal position. When a roller coaster assembly is in the low point the corresponding blade is in a full vertical or nearly fully vertical position. As the roller coaster moves along the track, the linear support hub 282 moves vertically along the linear guide shaft 296 to accommodate the changes in elevation. These elevational changes on the track are translated into vertical displacement of the connecting arm assemblies 208 which is converted to rotational motion of the blade arm and blade about the axis of the blade. During a 360 degree rotation of the blade about the axis 216 of the power shaft 206, the blade will rotate about its axis back and forth through roughly a 90° arc.

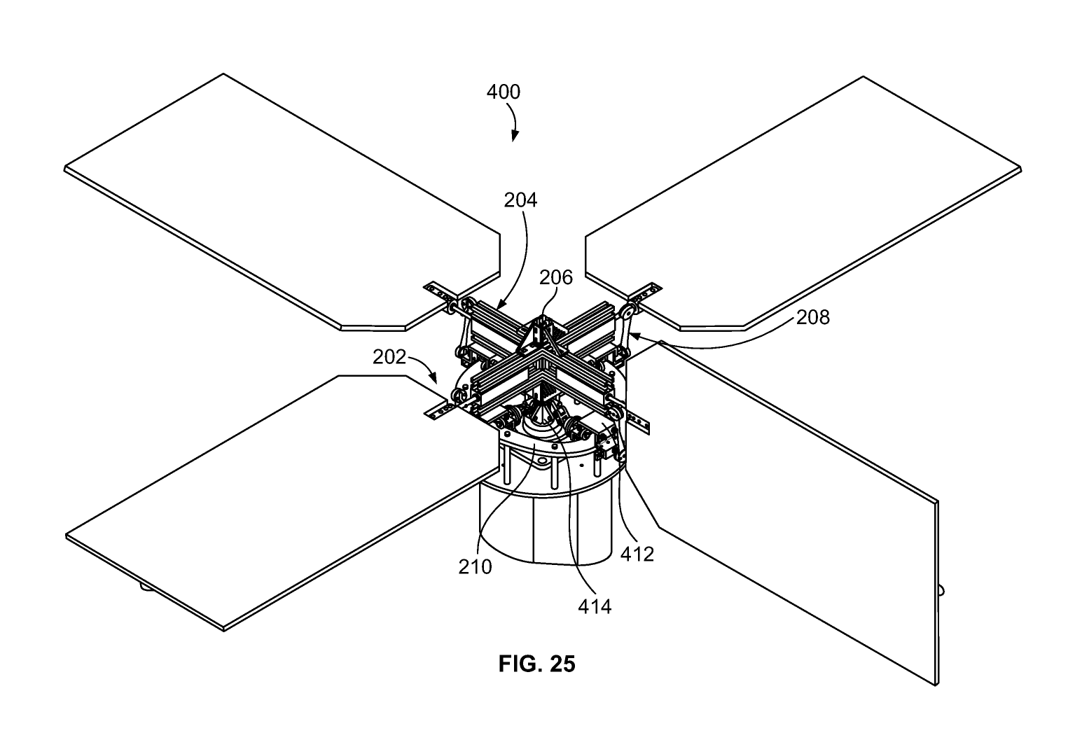

FIGS. 25-32B show another embodiment 400 of the first principal embodiment which has the same blade assembly 202, blade-arm support assembly 204 connecting the blade assembly 202 to a main power shaft 206, the same connecting arm assembly 208, and the same track 210 as the embodiment shown in FIGS. 18-24B and described above and the same reference numbers will be used to refer to the same parts. This embodiment differs from the prior embodiment in the roller coaster assembly 412, and the roller coaster support assembly 414 for connecting the roller coaster assembly 412 to the power shaft 206 for co-rotation about an axis 216 of the power shaft 206.

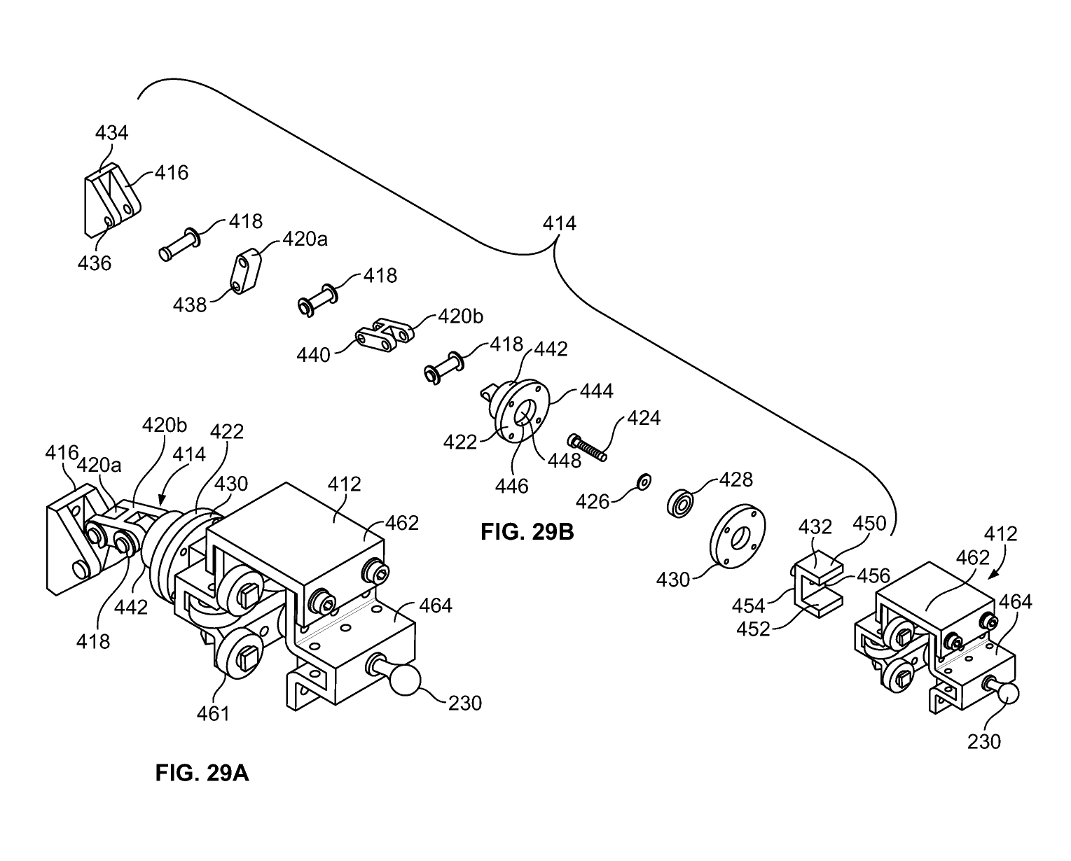

FIGS. 29A, B show the roller coaster and roller coaster support assemblies 412, 414. The roller coaster support assembly 414 has a linkage support 416, three clevis pins 418, two linkages 420A,B (to define a scissor arm assembly), a rotational hub 422, a cap screw 424, a lock washer 426, a ball bearing cup 428, a ball bearing capture plate 430, and a ball bearing mount 432. The linkage support 416 has a generally flat wall 434 with two generally triangular-shaped flanges extending from opposed edges of the flat wall and are separated by a gap. Each flange has a through hole 436 in alignment with one another. The linkage 420A has a through hole 438 at each of its opposed ends and a first end of the linkage is positioned in the gap between the flanges and secured in position with one of the clevis pins 418. The linkage 420B is generally H-shaped and has aligned through holes 440 and a first end secured to the second end of linkage 420A with a second clevis pin 418. The second end of the linkage 420B is connected to a first end of the rotational hub by a third clevis pin.

The rotational hub 422 has a second end with a generally cylindrical body 442 having an annular ring 444 surrounding an opening 446 into a chamber 448 of the hub. A ball bearing cup 428 is positioned in the opening and is secured in place with a ball bearing capture plate 430 which is secured to the annular ring 444 with threaded fasteners. The capture plate has an opening which is concentric with the opening 446. The cap screw 424 has a first end that is positioned in the chamber 448 and a second end that extends through a lock washer 426, the bearing cup 428, through a hole in the ball bearing mount 432 and threads into a bore on the roller coaster assembly. The ball bearing mount 432 is generally C-shaped member with a top and a bottom wall 450, 452 extending from a back wall 454 and defining a gap therebetween. The gap is dimensioned to engage a surface of the roller coaster assembly. The back wall 454 has a through hole to receive a portion of the cap screw 424.

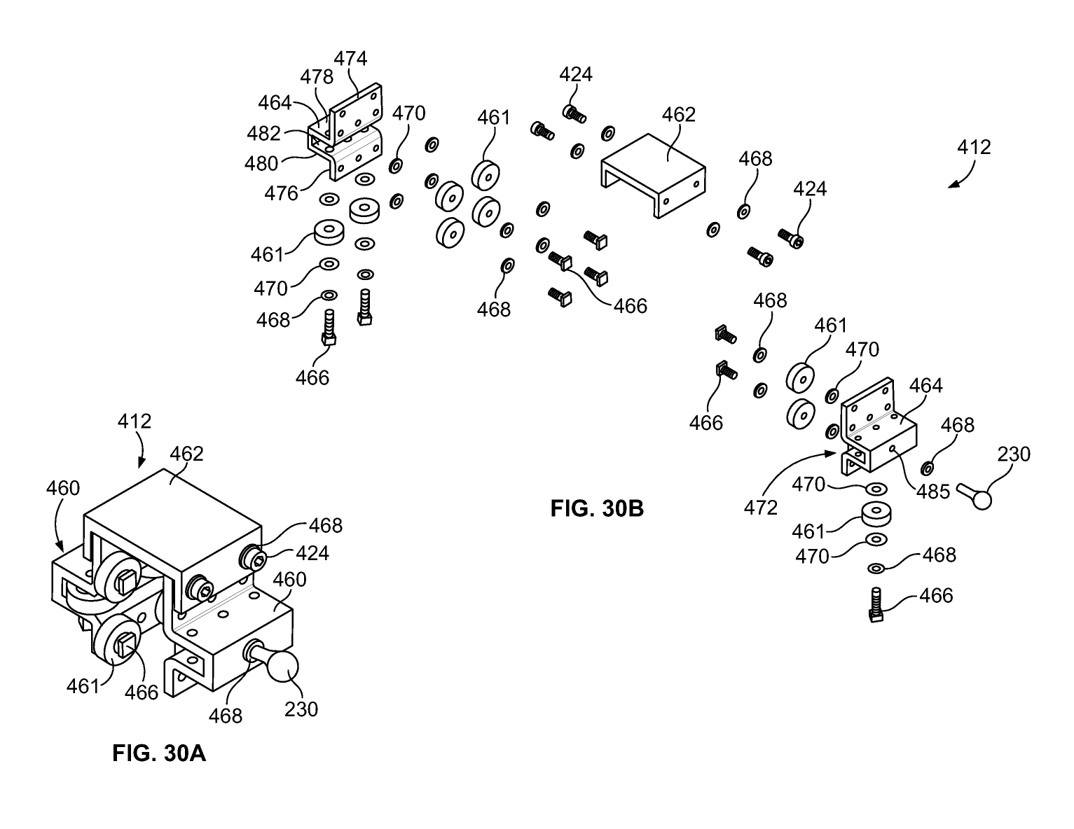

FIGS. 30-32 show a roller coaster assembly 412 having an opposed pair of roller coaster hub assemblies 460 mounted to opposite ends of a roller coaster coupling plate 462. Each roller coaster hub assembly 460 has a roller coaster hub 464 mounting a set of six wheels 461with wheel bolts 466, lock washers 468, and wheel washers 470. The roller coaster hub 464 has a generally C-shaped central portion 472, an upper flange 474 and a lower flange 476 extending respectively from an upper leg and a lower leg 478, 480 of the central portion 472 and a channel 482 positioned between the upper and lower legs. Two wheels are mounted in tandem in the channel with vertically extending wheel bolts 466 and two wheels are mounted on horizontal wheel bolts from each of the upper and lower flanges 474, 476. The two wheels mounted on vertical bolts contact an outer edge 484 of the track and the four horizontally mounted wheels have two wheels contacting a top surface of the track and the other two contacting a lower surface of the track. A spherical arm 230 is received in a threaded bore 485 on a back wall of the C-shaped member and connects the roller coaster assembly to the connecting arm assembly 208 as described above.

As the roller coaster assembly and the roller coaster support assembly 412, 414 move along the track 210, elevational changes in the track are accommodated by the pivoting of the clevis parts about their clevis pins. These elevational changes in the roller coaster assembly are transferred by the connecting arm assemblies and converted to rotational movement of the blades about their axes from a horizontal position to a vertical position as described herein.

FIGS. 33-35 show one preferred form of the second principal embodiment of a vertical axis wind turbine 500 having a power shaft 502 mounted for rotation about axis 504. This second principal embodiment of the design pertains to a system that uses a fixed circular surface in which the timing of the blade rotation cannot be modified. The blades will gradually turn into and out of the wind as they rotate about the power shaft axis. The wind turbine 500 has a base 506, a wobble assembly 508 mounted to the shaft 502 for rotation therewith about axis 504, two circumferentially spaced scissor assemblies 510 connecting the wobble assembly to the shaft 502, connector arms 512, and blade assemblies 514. The power shaft 502 has a rod portion 520 and an annular collar 522 attached thereto. The annular collar 522 has four bores 524 equally circumferentially spaced about the collar for receiving an end of an axle 526 of a blade assembly 514 and two clevi 528 extending radially from the collar and being equally circumferentially spaced from each other and one of each clevis 528 being equally spaced between a pair of adjacent bores 524.

The wobble assembly 508 has a ring 530 and six posts 532 extending radially from an outer peripheral surface of the ring 530 and being circumferentially spaced from one another. Each of the posts 532 terminate at a distal end in a spherical joint 534 for journaling an end of four connector arm assemblies 512 and two scissor arm assemblies 510. The wobble assembly 508 is mounted to a column 536 of the base 506 with a bearing assembly 538 positioned in an opening 540 of the ring 530. A bearing seat 544 supports the bearing assembly 538 and an upper base collar 542 mounted to the power shaft presses the bearing assembly 538 against the bearing seat 544 to prevent axial movement of the bearing assembly 538. FIG. 35 shows the bearing seat 544 forms an angle β with a horizontal line in the range of about 5° to about 30°, more preferably about 10°, or any range or combination of ranges therein.

The scissor assemblies 510 have first and second legs 550, 552 connected at ends by a pivot joint 554. The first leg 550 has a first end with a generally oval shaped head 556 with two through holes 558 for fastening a bearing plate 560 on an opposite face of the oval shaped head. The bearing plate 560 has an opening 562 into a chamber which in turn is mounted on one of the spherical joints 534. The second end 564 of the first leg terminates in a clevis for receiving a first end of the second leg 552 and a clevis pin secures the first end to the second end for pivotal movement of the first and second legs 550, 552 about the pin. A second end 570 of the second leg is secured by a pin to the clevis 528 on the power shaft thereby connecting the wobble assembly to the power shaft.

The connector arm assemblies 512 have first and second opposed ends 572, 574. The first end has a generally oval shaped head having a first inner face having a generally centrally disposed socket for connecting to one of the spherical joints on the wobble assembly. The second end 574 has an oval shaped head having a second inner face disposed at a 90° angle to the first inner face and having a generally centrally disposed socket for connecting to a spherical joint 584 on a blade assembly 514.

The blade assemblies 514 have a blade 578 and a blade holder 580 just at the blade assembly 74 described above. The blade holder 580 has two plates defining a generally U-shaped channel for receiving a tab extending from an edge of the blade. In this embodiment, the blade holder has a single axle 582 having a distal end for cooperatively engaging one of the bores 524 in the power shaft and having a spherical joint 584 for engaging the socket on the second inner face of the connector arm assembly.

The second principal embodiment of the vertical-axis wind turbine 500 operates in similar fashion to the first principal embodiment. When the blades are exposed to wind, the blades rotate about the axis 504. This in turn causes the scissor assemblies 510 to rotate about the axis 504, together with the wobble assembly 530, and the connector arm assemblies 512. Each of the connector arms move from a vertical maximum displacement where the associated blade is in a full flat, horizontal position, to a vertical minimum displacement where the associated blade is in a full vertical position. Just as in the first principal embodiment, in a first 180° segment of rotation of the blade assemblies about the axis 504 causes a movement of the blades through a 90° arc in a first direction about an axis through the axle 582 and during a second 180° segment of rotation causes a movement of the blades backward through the same 90° arc in the opposite direction from the first direction. The four blade assemblies can be considered two pairs of opposed blade assemblies where when one blade is rotating clockwise the opposed blade is rotating counterclockwise. Also, just as in the first principal embodiment, the rotation of the power shaft 502 will be connected to an energy capture mechanism 42.

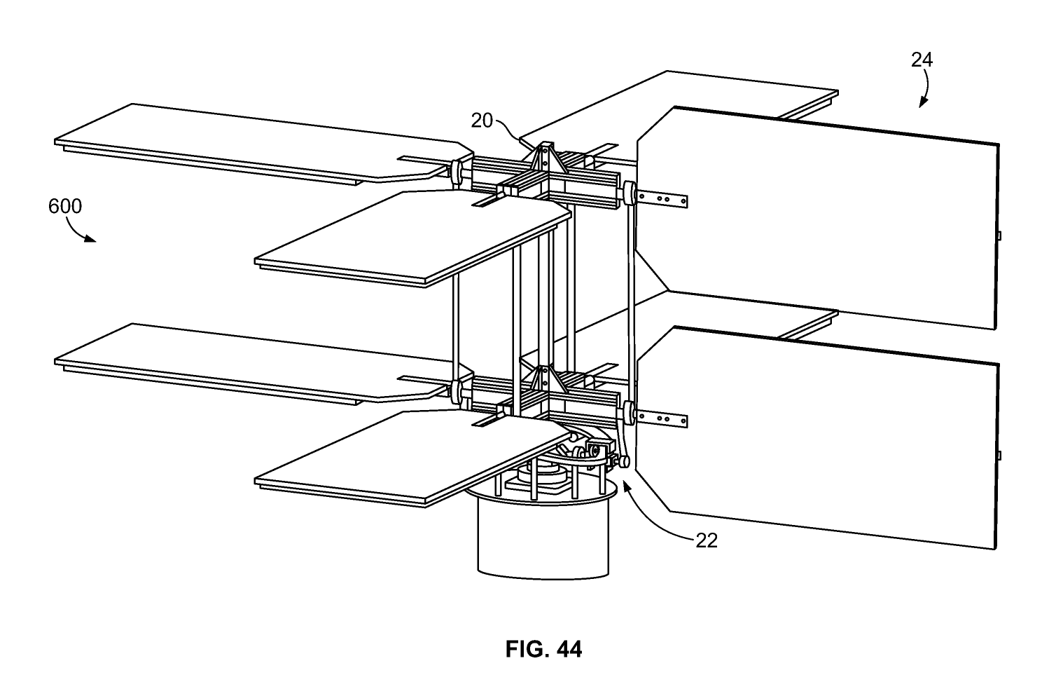

FIG. 44 shows an assembly 600 having more than a single wind turbine assembly associated with an axle, namely two wind turbines. Any one of the wind turbine embodiments disclosed herein can be used, and while two wind turbines are shown, it is contemplated that from 1 to 10 turbines could be used. In a preferred form of the invention, the two wind turbines are vertically spaced from one another, or stacked, and are concentrically disposed about and drive the same main power shaft 20.

### EXAMPLES

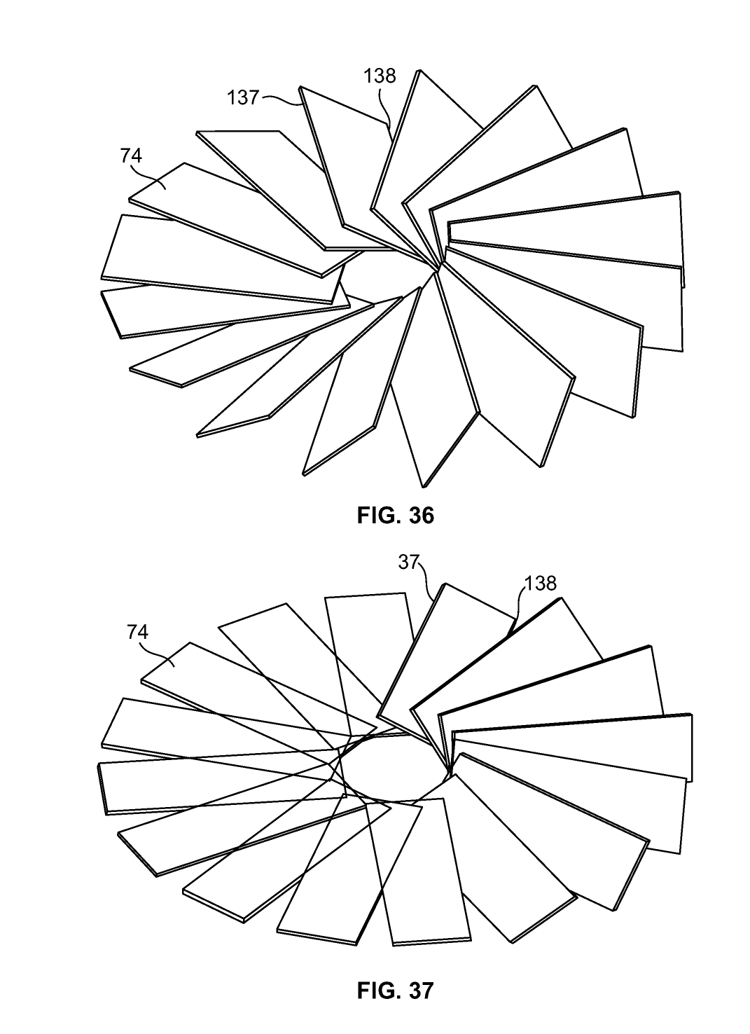

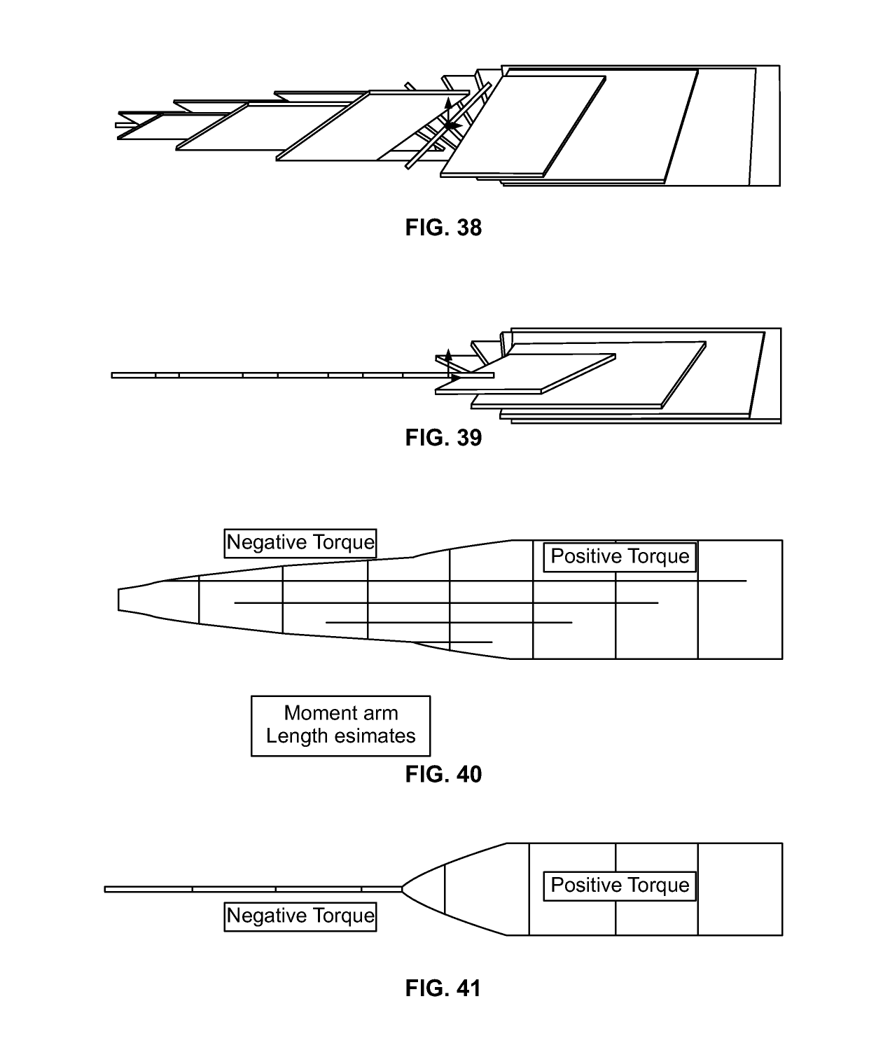

The first and second principal embodiments of the vertical-wind turbine were analyzed by creating a SolidWorks model that contained a physical representation of a blade at 22.5 degree increments as it travels around the track for the second principal embodiment and the first principal embodiment, respectively FIGS. 36 and 37. FIGS. 38 and 40 show the blades at various orientations to the wind and the amount of positive and negative torque developed during that portion of the rotation about the vertical axis. FIGS. 39 and 41 show the same for the first principal embodiment. The custom track model was designed to simulate ramps or connecting arcuate sections 60 that are 90 degrees apart with a ramp angle that spans 45 degrees. System efficiencies were calculated at various blade widths and blade lengths in order to generate efficiency curves for each model. The efficiencies were calculated by measuring the exposed blade surface area facing the wind, breaking the area into four even segments with a known moment arm then multiplying the surface area by the wind force at a given air velocity by each moment arm in order to calculate the resulting torque generated on the power shaft for each design.

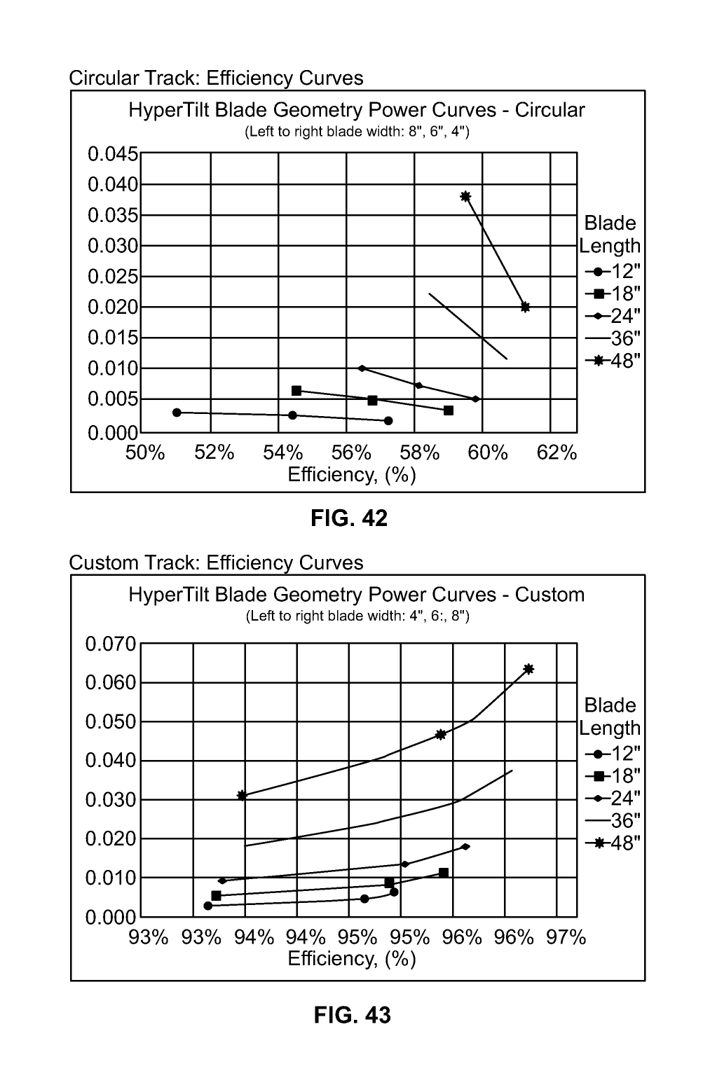

The resulting analysis concludes that the second principal embodiment theoretically captures a maximum of approximately 62% of the total torque available (FIG. 42). The first principal embodiment, utilizing a custom track design, can theoretically capture close to 100% of the torque available (FIG. 43). These values do not account for physical losses from friction, moment of inertia, or any drag from a motor or gear box.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims. The appended claims should be construed broadly and in a manner consistent with the spirit and the scope of the invention herein.

I claim:

1. A motion-translation mechanism for rotating blades of a vertical-axis wind turbine comprising:
a power shaft mounted for rotation about a first axis of rotation oriented vertically;
two axles mounted for rotation about the first axis, each axle having a second axis of rotation extending longitudinally therethrough and transverse to the first axis, each axle having a first end and a second end opposed to the first end, the first end being connected to the power shaft and the second end having a blade holder;
a surface mounted circumjacent the power shaft and axially spaced from the two axles; and
two connector arms one of each associated with an axle to define associated axles and associated connector arms, each connector arm having a third end and a fourth end opposed to the third end, the third end being connected to its associated axle, the fourth end being in cooperative engagement with the surface, each fourth end moves between a maximum vertical displacement to a minimum vertical displacement upon a 180° rotation of the power shaft to rotate each of the two axles 90° about the second axis of rotation.

2. The mechanism of claim 1 wherein each axle is equally circumferentially spaced from one another about the first axis.

3. The mechanism of claim 2 wherein each axle rotates about the second axis of rotation in equal angular amounts but in opposite directions with respect to the other and in response to rotation about the first axis.

4. The mechanism of claim 3 wherein the power shaft rotates about the first axis through a first 180° segment and a second 180° segment and wherein each axle rotates about the second axis of rotation through about a 90° arc in a direction during the first 180° segment and backward through the same 90° arc in an opposite direction in the second 180° segment.

5. The mechanism of claim 1 wherein the third end connects to the axle intermediate of the first end and the second end.

6. The mechanism of claim 1 wherein the third end connects to the first end.

7. The mechanism of claim 1 wherein the two connector arms rotate about the vertical axis with the power shaft.

8. The mechanism of claim 1 wherein the surface has a portion that defines a plane that intersects the vertical axis at an angle from about 5 degrees to about 60 degrees.

9. The mechanism of claim 1 wherein there are from 2 to 16 axles.

10. The mechanism of claim 1 wherein the surface is either stationary or rotates about the vertical axis.

11. The mechanism of claim 1 wherein the surface is a circuitous track.

12. The mechanism of claim 11 wherein the two connector arms move with respect to the surface.

13. The mechanism of claim 12 wherein each of the two connector arms has a member mounted for rotatable movement about a third axis of rotation.

14. The mechanism of claim 13 wherein the member is a wheel.

15. The mechanism of claim 13 wherein the member is two wheels.

16. The mechanism of claim 15 wherein one of the two wheels contacts a top surface of the track and second of the two wheels contacts a side edge of the track.

17. The mechanism of claim 1 wherein the fourth end has a surface engaging member pivotally mounted thereto for rotation about a fourth axis of rotation.

18. The mechanism of claim 17 wherein the surface engaging member is a wheel assembly.

19. The mechanism of claim 18 wherein the wheel assembly has from one to six wheels.

20. The mechanism of claim 18 wherein the wheel assembly has two wheels each having its own axis of rotation and the axes being transverse to one another.

21. The mechanism of claim 1 wherein each of the two connector arms has a center bearing having a fifth axis of rotation, the center bearing being pivotally mounted to the connector arm for rotation about a sixth axis of rotation transverse to the fifth axis of rotation.

22. The mechanism of claim 1 wherein the surface has a first circuitous track and a second circuitous track axially spaced from the first track.

23. The mechanism of claim 22 wherein each of the two connector arms has at one end a first track engaging member, and at an opposed end a second track engaging member.

24. The mechanism of claim 23 wherein the third end of each of the two connector arms is disposed between the first track engaging member and the second track engaging member and is axially spaced from both.

25. The mechanism of claim 24 wherein the first track engaging member is a first wheel assembly.

26. The mechanism of claim 25 wherein the first wheel assembly is pivotally mounted for rotation about a seventh axis of rotation.

27. The mechanism of claim 26 wherein the second track engaging member is a second wheel assembly pivotally mounted for rotation about an eighth axis of rotation.

28. The mechanism of claim 24 further comprising a bearing assembly on each of the two connector arms for rotatably mounting the third end of its associated axle.

29. The mechanism of claim 28 wherein the bearing assembly is pivotally mounted to each of the two connector arms for rotation about a tenth axis of rotation transverse to the second axis of rotation.

30. The mechanism of claim 22 further comprising a base and wherein the first track has a first portion a first axial distance from the base, a second portion having a second axial distance from the base being less than the first axial distance and a sloping portion connecting the first portion and the second portion.

31. The mechanism of claim 1 wherein the surface comprises a wobble assembly having a ring rotatably mounted for rotation about an eleventh axis of rotation that forms an angle of from about 5° to about 60° to the first axis of rotation.

32. The mechanism of claim 31 wherein the ring has a two posts extending radially from an outer peripheral edge of the ring and being circumferentially spaced from one another.

33. The mechanism of claim 32 wherein one of each of the two posts connects to one of each of the two connector arms.

34. The mechanism of claim 33 wherein the connector arm has a first segment and a second segment pivotally connected to the first segment.

35. The mechanism of claim 1 wherein the blade holder has a body having opposed ends with one end defining a channel for receiving a portion of a blade and an opposed end having a radially extending blade support arm.

36. The mechanism of claim 35 further comprising a blade lever arm radially extending from the opposed end of the body and being spaced from the blade support arm.
